(19) United States
(12) Patent Application Publication
(10) Pub. No.: US 2017/0213169 A1
(43) Pub. Date: Jul. 27, 2017

(54) SOCIAL NETWORKING SYSTEM FOR ORGANIZATION MANAGEMENT

(71) Applicant: Vantage Agora Inc., Mentor, OH (US)

(72) Inventors: Harsha Chaturvedi, Battle Creek, MI (US); Sudhir Achar, Concord, OH (US)

(21) Appl. No.: 15/366,879

(22) Filed: Dec. 1, 2016

Related U.S. Application Data
(63) Continuation of application No. 13/477,042, filed on May 21, 2012, now abandoned.

(51) Int. Cl. G06Q 10/06; G06Q 50/00

(52) U.S. Cl. CPC G06Q 10/0639; G06Q 50/01

(57) ABSTRACT

A computer implemented method and system for managing an organization in a virtual social network environment provides an organization management platform accessible to employees and clients over a communication network. The organization management platform acquires target goal criteria of the organization via a graphical user interface over the communication network, and creates multiple organizational groups based on the target goal criteria. The organization management platform registers the employees with one or more organizational groups selected by the employees. The organization management platform acquires one or more tasks and rules for performing the tasks that enable the employees to fulfill the target goal criteria. The organization management platform measures performance of the tasks by each of the employees in each of the organizational groups based on the rules and performance criteria, and allocates one or more units of electronic currency to each of the employees based on the measured performance.

### CROSS REFERENCE TO RELATED APPLICATION

This application is a continuation of U.S. patent application Ser. No. 13/477,042, filed on May 21, 2012 and entitled Social Networking System for Organization Management (Attorney Docket No. 37316/04000).

### BACKGROUND

The development and deployment of technological social networking systems and the possibility of instant reach to information, particularly in a wireless environment has changed the landscape in which companies are structured and operate today. Notwithstanding such developments, most organizations continue to employ conventional organizational models such as enterprise resource planning (FRP) models that are often found ineffective for managing employees particularly in a knowledge based organization. Moreover, even when some organizations elect to change their organizational structure, the change is often disruptive since they mandate employees to change their complete operating methodology within a short span of time. Furthermore, most organizations often fail to foster a merit-centric environment without having to resort to conventional “carrot and stick” methods which offer a combination of rewards and penalties to induce behavior.

Furthermore, most organizations are divided into a set of conventional departments based on the enterprise resource planning (FRP) model. This is due to the fact that from the times of operation of mass manufacturing plants, in view of the state of technology and knowledge that workers possessed at that time, it appeared logical to have separate departments for finance, human resource, administration, etc. The reasons for the organizational structure prevalent then was based on a number of factors such as division of labor, a lack of trust in the capability of an employee to handle multiple tasks, for example, the assumption that a foreman on a manufacturing floor was not capable of appraising his employees in areas such as human resource, finance, payroll, engineering, etc., and lack of information, for example, the assumption that it would not be possible for an engineer to know more about suppliers than a person in charge of procurement, etc. Therefore, the basic premise for the conventional design of the organizational structure was based on the assumption that employees need support from another department or a set of people that focus and know their own set of activities, and that employees are not responsible, that is, they need to be policed, and do not have all the necessary information to make their own decisions, thereby requiring all decisions to be officially approved. This was primarily applicable to a “one-dimensional” workforce, that is, a workforce that is not equipped with the knowledge of work areas external to the purview of immediate work related activities and that needs the aid of multiple support services. For example, line management in a typical one-dimensional workforce is restricted, for example, only to engineering related activities. However, with the advent of intranet and the internet and the widespread accessibility of information, the concept of a one-dimensional workforce has been rendered sufficiently obsolete since employees can update themselves on a number of work areas and train themselves with multiple employment skills.

Notwithstanding a knowledgeable workforce and advanced communication systems, organizations are continued to be built to strengthen the mass manufacturing paradigms of people management and company management using divide and conquer methodologies that have further limited the possibility of creating empowered employees who can manage themselves. As used herein, the term an “empowered employee” refers to an employee who has the freedom to complete his/her job to the best of his/her ability and make decisions required for the job free from external interference, that can generate value to both the organization and the clients of the organization. Conventional organizational structures are typically approval based organizational structures that are designed with a hierarchical or matrix-like structure. These organizations often have various levels of approval built into their systems based on the assumption that employees do not have sufficient knowledge or experience to competently perform or complete their work. Furthermore, approval based organizational structures often operate on the assumption that employees with more experience in a specialized knowledge area or a department are more responsible and knowledgeable in making decisions. Such an organizational structure inherently does not allow for the possibility of employees being empowered to make their own decisions. Therefore, the efforts of empowered employees are often futile since in the absence of an organizational structure and a system to support the empowered employees to make decisions, empowered employees are unable to make decisions or execute innovative ideas, being often dependent on approval for their decisions on a person who may be less apprised with core ideas of a technology or implications of the decisions or innovative ideas on the organization and clients of the organization.

Furthermore, most organizations, under a line management system, push non-managerial employees such as engineers, finance professionals, etc., towards managing employees, evaluating the employees, managing pay of the employees, etc., thereby reducing specialized departments such as human resource, administration, finance and other support functions to bottlenecks in the organizational structure instead of enhancing the engineering teams. Furthermore, these line managers often find it difficult to enforce human resource related activities among the employees of the organization due to the absence of an infrastructure that incentivizes teams to perform their human resource activities willingly. Moreover, since most projects are characterized by small teams and employees are not actively involved in corporate activities of the organization, most employees often do not feel a sense of belonging or the capability of contributing to the entire organization.

Furthermore, in conventional organizational structures, when employees try to contribute to the organization, the employees are sometimes stifled by red tape or divisions between various functional teams within the organization because of the inherent organizational structure. Furthermore, in an example, procurement of technical or non-technical raw materials may be performed better by line employees than procurement staff who have the advantage of group buying and better tools. Consider an example of an employee who volunteers to directly procure hardware components needed for a project, since the employee is aware of the technical details of the hardware components and current market pricing for the hardware components. A procurement department may not be equipped to handle these requirements; however, it is responsible for executing these requirements. Therefore, the individual employee and the procurement department may be in opposition, necessitating a mediation of an executive leadership to help sort out the issue, although the employee and the procurement department are both operating according to their respective key result areas.

Furthermore, in a globalized environment, personal space and workspace connectivity has made redundant the need to be physically present at the office to conduct business. Moreover, practical issues such as commute, travel costs, infrastructure costs, geopolitical issues, etc., have further driven the need for working off campus. For example, different employees may be constrained to reach office at different times. To add to the problem, most employees working for an organization are placed in different work locations across the world and operate on their individual timelines, thereby affecting synchronization of meetings, work times, etc. Therefore, there is a need for an efficient virtual platform that can coordinate the activities of the organization across different geographical destinations.

Furthermore, the development of a networked and connected world has resulted in mushrooming of social networks. There are, for example, four types of social networks: interest groups (1G), first generation (G1) social networks, second generation (G2) social networks, and third generation (G3) social networks. An interest group, for example, a news group, an online technical group, etc., is the most basic form of a social network where the users are unaware of the identity or the avatar of each of the members of the group who contribute to the social network. Therefore, even when a member of the group makes a factual mistake or posts a controversial message, the message may be flamed or deleted by a moderator and there is no penalty laid on the member. The other members of the group do not know or want to know about that member; instead, the members of the group are only interested in the views of the member's avatar. In first generation (G1) social networks, for example, Twitter® of Twitter, Inc., Facebook® of Facebook, Inc., etc., that are the most prevalent social networks, there is an interest in the identity of the user. Although in such social networks, there is an implied sense of right and wrong imposed by the social network, the ethical structure of the organization is not necessarily well defined. However, there is a consequence for every action of the user in the real world. For example, a member of a social network may call up another member and express disagreement with or question the rationale behind a message posted on the social network. However, there is no inherent system within the social network that enforces a sense of right and wrong. That is, in these social networks, while there is interest in the creator, there is no interest or influence on the ethical framework of the social network. However, in third generation (G3) social networks, for example, Second Life® of Linden Research, Inc., or Super Life, there is an inbuilt consequence for every action that a member of the social network takes within the social network. The third generation social network is a more evolved social network, where a set of people, for example, avatars or operators in the social network have defined a well defined ethical framework, that is, the notion of right and wrong is imposed on the social network.

Hence, there is a long felt but unresolved need for a computer implemented method and system that manages an organization of employees as social networks in a virtual environment and enables self-governance and management by the employees. Moreover, there is a need for a computer implemented method and system that objectively incentivizes the performance of tasks by employees in accordance with goals of the organization. Furthermore, there is a need for a computer implemented method and system that provides a platform for employees to interact and execute tasks with the knowledge that they have and collaborate among themselves to find solutions to their problems and make their own decisions for day-to-day operations in the organization. Furthermore, there is a need for a computer implemented method and system that organizes organizations according to knowledge workers, who have access to the latest technologies and who can decide and manage their area of operation. Furthermore, there is a need for a computer implemented method and system that facilitates a scalable, sell-sustaining, and self-governing organization.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above stated needs for managing an organization of employees as social networks in a virtual environment and enabling self-governance and management by the employees. Moreover, the computer implemented method and system disclosed herein objectively incentivizes the performance of tasks by employees in accordance with goals of the organization. The computer implemented method and system disclosed herein provides a platform for employees to interact and execute tasks with the knowledge that they have and collaborate among themselves to find solutions to their problems and make their own decisions for day-to-day operations in the organization. The computer implemented method and system disclosed herein organizes organizations according to knowledge workers, who have access to the latest technologies and who can decide and manage their area of operation. The computer implemented method and system disclosed herein facilitates a scalable, self-sustaining, and self-governing organization.

The computer implemented method and system disclosed herein redefines the organizational structure and the operation of organizations at the ground level. The computer implemented method and system disclosed herein is not a disruptive system that requires employees and clients to change their operating methods instantaneously. For example, the computer implemented method and system disclosed herein enables management of the organization in a virtual social network environment compatibly with a conventional matrix or a hierarchical organization. The computer implemented method and system disclosed herein divides the overall functioning of the organization into strategic long term planning operations and day-to-day operations. The computer implemented method and system disclosed herein manages the day-to-day functioning of the organization. The computer implemented method and system disclosed herein fosters an environment of merit based incentives without resorting to conventional carrot and stick methods. Furthermore, the computer implemented method and system disclosed herein provides an organizational structure that enables employees to work across departments to help the organization and create more value for the clients of the organization. The computer implemented method and system disclosed herein enables employees to be a part of a non-threatening work environment and to develop their leadership skills, thereby leading to an empowered organizational structure. The computer implemented method and system disclosed herein enables operation of an organization as a set of social networks that enforce discipline inside-out leading to more controllable organizations by empowering employees, particularly in a high knowledge workforce. The computer implemented method and system disclosed herein enables empowered employees to work with an organizational structure that harbors innovation, rewards risk taking and leadership, and motivates employees to go beyond their call of duty, thereby reducing attrition.

The computer implemented method and system disclosed herein manages an organization in a virtual social network environment. As used herein, the term “virtual social network environment” refers to an online or computer simulated environment configured as a social network that links one or more groups of users, for example, employees of an organization and facilitates performance of tasks and exchange of information by the users with other users in the social network. The computer implemented method and system disclosed herein provides an organization management platform comprising at least one processor configured to execute the management of the organization in the virtual social network environment. The organization management platform is accessible to multiple employees and clients of the organization over a communication network. The organization management platform acquires target goal criteria of the organization from one or more employees of the organization via a graphical user interface (GUI) provided by the organization management platform over the communication network. The target goal criteria comprise, for example, key result areas of the organization, service level agreements associated with each of the key result areas, predetermined characteristics for creation of organizational groups, etc. In an embodiment, the organization management platform allocates individual key result areas for each of the employees associated with the organizational groups created by the organization management platform, from the target goal criteria acquired for the organization.

The organization management platform creates multiple organizational groups in the virtual social network environment based on the acquired target goal criteria. As used herein, the term “organizational group” refers to a collection of users, for example, employees of the organization who work on one or more specific tasks defined based on initiatives of the employees that facilitate empowerment of the employees and fulfillment of the target goal criteria of the organization. In an embodiment, the organization management platform generates and provides reusable templates, for example, widgets on the GUI of the organization management platform for dynamically generating organizational groups and for enabling the employees of the organization to manage the organizational groups. The organization management platform registers one or more of the employees with one or more of the organizational groups selected by the employees via the GUI over the communication network. In an embodiment, the registration of the employees with the organizational groups comprises selecting a virtual avatar for each of the employees in the organization based on inputs received from each of the employees via the GUI over the communication network, for identifying each of the employees in the organization. The organization management platform acquires one or more tasks and one or more rules for performing the tasks that enable the employees in each of the selected organizational groups to fulfill the acquired target goal criteria, via the GUI, over the communication network.

In an embodiment, the organization management platform provides one or more configurable dashboard display interfaces on the GUI for transmitting and/or receiving notifications of status of the performance of the tasks associated with the selected organizational groups from one or more of the employees to other employees. For example, the organization management platform transmits notification messages querying the status of performance of the tasks, and receives notification messages replying to the queries, as part of a chat conversation initiated among the employees in each of the selected organizational groups on the configurable dashboard display interfaces on the GUI. In an embodiment, the organization management platform maps the acquired tasks to calendar events, tracks the calendar events associated with the organizational groups, transmits requests for performing the tasks mapped to the calendar events to each of the employees in each of the selected organizational groups, and transmits reminder notifications of the calendar events periodically to each of the employees in each of the selected organizational groups. The organization management platform measures performance of the tasks by each of the employees in each of the selected organizational groups, based on the acquired rules and performance criteria. The performance criteria for measuring the performance of the employees comprise, for example, quality of work delivered by each employee, attendance of each employee, etc. In an embodiment, the organization management platform selectively displays information on progress of the tasks performed by each of the employees in each of the selected organizational groups on one or more of the configurable dashboard display interfaces on the GUI, to the employees and the clients of the organization based on a profile of each of the employees and the clients of the organization.

The organization management platform allocates one or more units of electronic currency to each of the employees in each of the selected organizational groups based on the measured performance. The units of electronic currency comprise, for example, points, points redeemable for cash, points redeemable for an item of value, points redeemable for a promotion, a stock share in the organization, a job transfer within the organization, coupons, special discounts on products and/or services of the organization, etc., and any combination thereof. In an embodiment, the organization management platform allocates a positive electronic currency for a successful performance of the tasks in accordance with the acquired rules to fulfill the acquired target goal criteria of the organization, and allocates a negative electronic currency for a failed performance of the tasks in accordance with the acquired rules to fulfill the acquired target goal criteria. In an embodiment, the organization management platform allocates a greater number of units of electronic currency to each of the employees in each of the selected organizational groups, when each of the employees performs one or more other tasks in one or more other organizational groups.

In an embodiment, the organization management platform allocates the units of electronic currency to each of the employees in each of the selected organizational groups based on a weight assigned to each of the tasks and/or each of the organizational groups. The organization management platform assigns each weight, for example, based on predetermined weighting criteria. The organization management platform accumulates the units of electronic currency allocated to each of the employees across the selected organizational groups in an incentive account associated with each of the employees. Furthermore, the organization management platform monitors a total number of the allocated units of electronic currency accrued by each of the employees over a predetermined duration of time for tracking progress of each of the employees in the organization. In an embodiment, the organization management platform dynamically transforms the selected virtual avatar of each of the employees when each of the employees accrues a predetermined number of the allocated units of electronic currency.

In an embodiment, the organization management platform monitors progress in the performance of the tasks by each of the employees in each of the selected organizational groups over a predetermined duration of time, for example, by tracking the allocated units of electronic currency accrued by each of the employees over the predetermined duration of time. In another embodiment, the organization management platform monitors the relative progress of each of the organizational groups based on the performance of the tasks by each of the employees associated with each of the organizational groups over a predetermined duration of time. In an embodiment, the organization management platform performs a root cause analysis for identifying one or more causes of failure in performing the tasks, and for identifying the organizational groups responsible for the identified causes of failure. The organization management platform automatically updates the acquired rules for the performance of the tasks for overcoming the identified causes of failure. In an embodiment, the organization management platform iteratively generates a series of linked queries for identifying the causes of failure in performing the tasks, and transmits the generated series of linked queries to the organizational groups via the GUI for obtaining responses that identify the causes of failure from the employees in each of the organizational groups. Furthermore, the organization management platform generates and tracks completion of a product knowledge test via the GUI for overcoming the identified causes of failure notified to each of the employees of the organizational groups associated with the identified causes of failure.

In an embodiment, the organization management platform generates recommendations for successful performance of the tasks and notifies the generated recommendations to each of the employees in the selected organizational groups via the GUI. In an embodiment, the organization management platform performs a behavioral analysis of each of the employees in the selected organizational groups based on an analysis of conformance of each of the employees with the acquired rules, and a number of the allocated units of electronic currency accrued by each of the employees for each of the acquired tasks, and an analysis of interactions among the employees in the organization. The organization management platform extracts the interactions from one or more configurable dashboard display interfaces on the GUI for performing the behavioral analysis.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for managing an organization in a virtual social network environment.

FIG. 2 exemplarily illustrates a screenshot of a graphical user interface provided by an organization management platform, displaying links to templates for managing organizational groups associated with each of the employees.

FIG. 3 exemplarily illustrates a screenshot of the graphical user interface provided by the organization management platform, displaying a virtual avatar selected by an employee of an organizational group and characteristic profile information associated with the virtual avatar.

FIGS. 4A-4B exemplarily illustrate screenshots of a graphical user interface provided by the organization management platform, displaying acquisition of rules for a task to be performed by an organizational group and a corresponding notification on the status of the task.

FIG. 5 exemplarily illustrates a screenshot of a graphical user interface provided by the organization management platform, displaying initiation of an operating rhythm for an organizational group.

FIG. 6 exemplarily illustrates a schematic flow diagram comprising the steps performed by the organization management platform for managing an organization in a virtual social network environment.

FIG. 7 exemplarily illustrates a screenshot of a configurable dashboard display interface provided on the graphical user interface by the organization management platform, displaying interactions among employees of an organizational group in the virtual social network environment.

FIG. 8 exemplarily illustrates a screenshot of a configurable dashboard display interface provided on the graphical user interface by the organization management platform for displaying status and trends in performance of tasks by employees in an organizational group.

FIG. 9 exemplarily illustrates a screenshot of a graphical user interface provided by the organization management platform, displaying an escalation matrix configured by the organization management platform for each of the employees.

FIGS. 10A-10B exemplarily illustrate screenshots of the graphical user interface provided by the organization management platform, displaying reports of a root cause analysis performed by the organization management platform for identifying causes of failure reported by an organizational group.

FIG. 11 exemplarily illustrates a screenshot of a graphical user interface provided by the organization management platform, displaying an audit report generated by the organization management platform.

FIGS. 12A-12C exemplarily illustrate a flowchart comprising the steps for managing an organization in a virtual social network environment.

FIGS. 13A-13B exemplarily illustrate a graphical representation of a series of organizational groups selected and traversed by an employee in the organization over a predetermined duration of time.

FIG. 14 exemplarily illustrates a computer implemented system for managing an organization in a virtual social network environment.

FIG. 15 exemplarily illustrates a schematic diagram of a logical structure of the organization management platform in a virtual social network environment.

FIG. 16 exemplarily illustrates the architecture of a computer system employed by the organization management platform for managing an organization in a virtual social network environment.

### DETAILED DESCRIPTION OF THE INVENTION

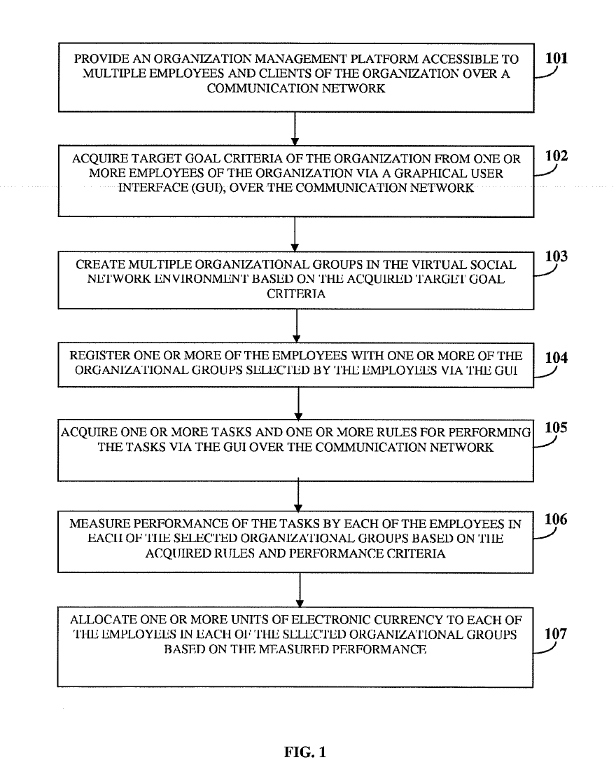

FIG. 1 illustrates a computer implemented method for managing an organization in a virtual social network environment. As used herein, the term “organization” refers to any institution that employs or manages individuals for performing target goals in different industries, for example, the services industry comprising healthcare, information technology, insurance, finance, manufacture, fast moving technology companies, etc. The organizations comprise, for example, corporate organizations, government agencies, offices, educational institutions, medical organizations, etc. For purposes of illustration, the detailed description refers to management of an organization such as a company in a corporate environment; however the scope of the computer implemented method and system disclosed herein is not limited to management of employees in a company but may be extended to include management of any set of individuals in multiple different goal based environments, for example, industries associated with healthcare, information technology, insurance, finance, manufacture, fast moving technology companies, etc. Also, as used herein, the term “virtual social network environment” refers to an online or computer simulated environment configured as a social network that links one or more groups of users, for example, employees of an organization and facilitates performance of tasks and exchange of information by the users with other users in the social network.

The computer implemented method disclosed herein provides 101 an organization management platform accessible to multiple employees and clients of the organization over a communication network, for example, the internet, an intranet, a local area network, a wide area network, a communication network implementing Wi-Fi® of the Wireless Ethernet Compatibility Alliance, Inc., a cellular network, a mobile communication network, etc. The organization management platform comprises at least one processor configured to execute the management of the organization in the virtual social network environment. The organization management platform facilitates virtual interactions between users, for example, employees of the organization and between the employees and clients of the organization. The organization management platform is

The organization management platform acquires 102 target goal criteria of the organization from one or more employees of the organization via a graphical user interface (GUI) provided by the organization management platform, over the communication network. The target goal criteria comprise, for example, key result areas (KRAs) of the organization, service level agreements associated with each of the key result areas, predetermined characteristics for creation of organizational groups by the organization management platform, etc. The characteristics for creation of the organizational groups comprise, for example, internal objectives of the organization, interest areas reported by the employees of the organization, etc. In an embodiment, the target goal criteria are acquired for each individual employee of the organization. The target goal criteria are also acquired for each department in the organization and then aggregated over the entire organization to enable the organization achieve targeted goals of the organization. The key result area defines what an organization is trying to achieve. That is, the key result areas refer to areas of outcomes or outputs for which an employee or a department of the organization is responsible. The key result areas of the organization are, for example, improving quality of a product or a service delivered by the organization, improving cost effectiveness of the product or the service, etc.

The service level agreement defines a quantitative measure for each of the key result areas that is acceptable to entities entering into the service level agreement. Therefore, the service level agreement decides how good the key result areas need to be, for the key result areas to be acceptable. Consider an example where a key result area for the organization is an improvement in quality of a software code and a time of delivery of the software code by a predetermined date by the organization to a client of the organization. The service level agreement between the organization and the client defines, for example, a predetermined number of allowable non-fatal errors such as thirty allowable errors in the software code provided to the client, a predetermined date within which the software code is deliverable to the client, etc. Furthermore, the internal service level agreement between the organization and the employees of an organizational group responsible for the delivery of the software code comprises, for example, another predetermined number of allowable errors in the software code such as a total of fifteen allowable errors in the software code prior to preliminary testing of the software code. The number of allowable errors in the software code set by the organization in the service level agreement with the employees may be lesser compared to the number of allowable errors set in the service level agreement with the client in order to accommodate the requirements set by the service level agreement with the client. Therefore, the service level agreement between the organization and the employees of an organizational group may be defined based on the service level agreement between the organization and the client. The organization management platform provides templates on the GUI for dynamically configuring service level agreements between employees who execute the requirements herein referred to as “doers” and managers, between the managers and the clients, etc., within the organization.

In an embodiment, the organization management platform allocates individual key result areas for each of the employees in the organizational groups from the acquired target goal criteria defined for the organization. The organization management platform allocates the individual key result areas based on the overall key result areas defined for the organization. The individual key result areas comprise, for example, the quality of performance of individual tasks of each of the employees, attendance of an employee, compliance with predetermined standards, etc. In an example, the organization management platform allocates individual key result areas to match a balanced scorecard system that aligns the objectives of the employee towards the target goal criteria comprising the overall key result areas for the entire organization. Furthermore, the organization management platform provides a series of workflows in the GUI of the organization management platform that map the individual key result areas for each of the employees to the overall key result areas of the organization and enable the setting of the key result areas for each of the employees of the organization.

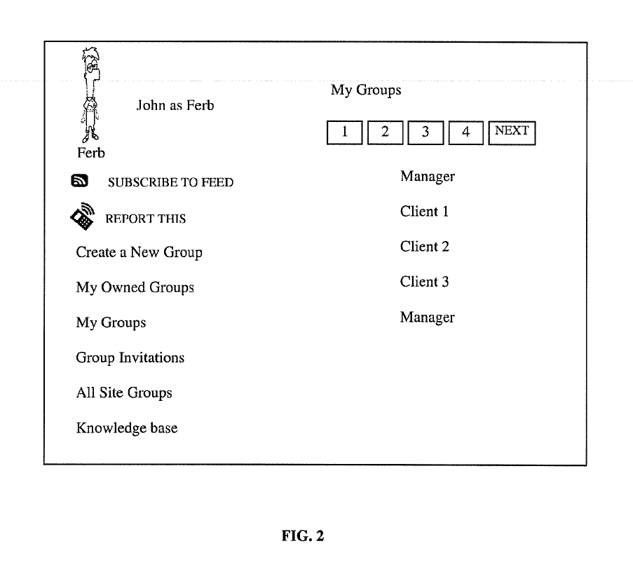

The organization management platform creates 103 multiple organizational groups in the virtual social network environment based on the acquired target goal criteria. As used herein, the term “organizational group” refers to a collection of users, for example, employees of the organization who work on one or more specific tasks defined based on initiatives of the employees that facilitate empowerment of the employees and fulfillment of the target goal criteria of the organization. In an embodiment, the organization management platform generates and provides reusable templates, for example, widgets on the GUI for dynamically generating the organizational groups and for enabling management of the organizational groups by the employees of the organization as disclosed in the detailed description of FIG. 2. For example, the organization management platform provides built-in templates with selective write access that can be modified by an authorized employee to add an organizational group, delete an organizational group, etc. The templates allow the employees to reuse the preexisting organizational groups.

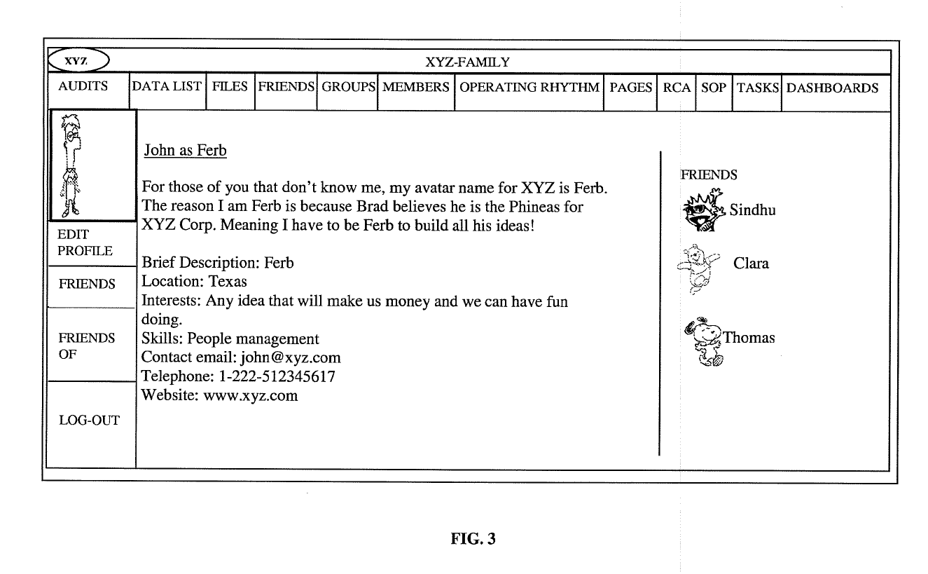

The organization management platform registers 104 one or more of the employees with one or more of the organizational groups selected by the employees via the GUI of the organization management platform over the communication network. In an embodiment, the organization management platform creates a user account for each of the employees, which is accessible by each of the employees on the GUI provided by the organization management platform as exemplarily illustrated in FIGS. 2-3. The user account allows each of the employees to manage their tasks and activities in the organizational groups to which they belong. Each of the organizational groups comprises, for example, doers, managers, and clients. A doer is an employee who is, for example, involved in design, development, testing, or customer service associated with a particular product or service. A manager is an employee who supervises functioning of the organizational group. A client is a user who receives products or services from the organization. The organization management platform allows the clients to be a part of the organizational group to facilitate supervision of the progress of a particular task associated with the creation of a product or a service for the client.

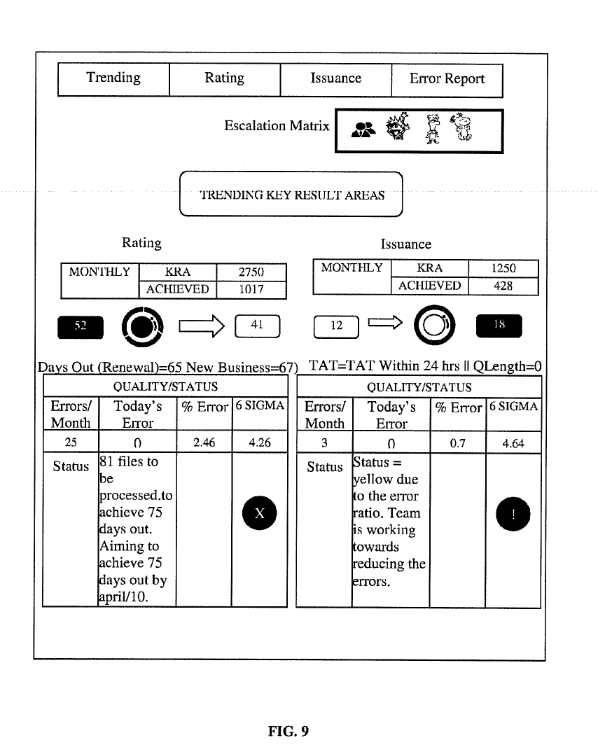

In an embodiment, the registration of the employees with their respective organizational groups comprises selecting a virtual avatar for each of the employees in the organization based on inputs received from each of the employees via the GUI over the communication network, for identifying each of the employees in the organization. As used herein, the term “virtual avatar” refers to a virtual identity representation of an actual identity of an employee in the virtual social network environment. The virtual avatar allows each of the employees to create a new persona for themselves in the virtual social network environment for communication with other employees within the organization. The organization management platform tags all tasks, electronic currency accrued by the employee, etc., to the virtual avatar of the employee. Furthermore, the organization management platform selects a virtual avatar for every client associated with the organization or a supplier delivering raw materials to the organization. The organization management platform provides a configurable dashboard display interface that allows employees to communicate with one another using their respective virtual avatars. Furthermore, in another embodiment, the organization management platform provides an escalation matrix comprising virtual avatar icons on the GUI as exemplarily illustrated in FIG. 9. An employee can click on one or more of the virtual avatar icons to escalate issues to the employees associated with the clicked virtual avatar icons.

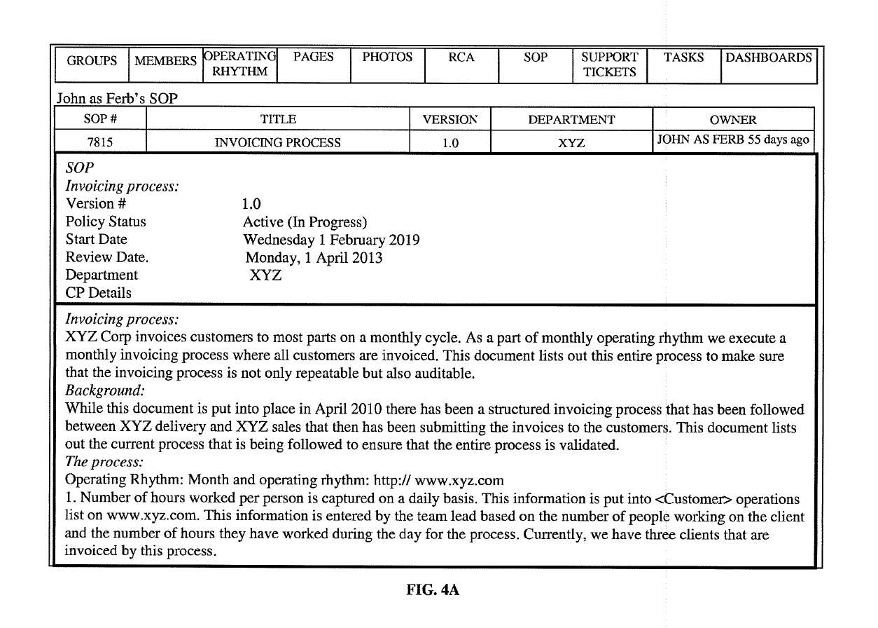

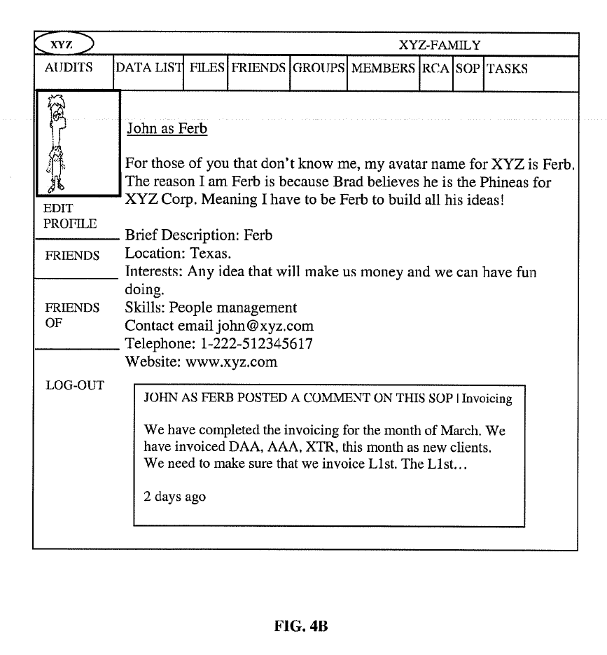

The organization management platform acquires 105 one or more tasks and one or more rules for performing the tasks that enable the employees in each of the selected organizational groups to fulfill the acquired target goal criteria, via the GUI over the communication network. The rules for performing the tasks are, for example, standard operating procedures that define functioning of an organizational group based on the key result areas of the organization and the service level agreements for that particular organizational group. A set of rules represented as a standard operating procedure of an organizational group is exemplarily illustrated in FIG. 4A. Furthermore, a fundamental framework for the rules, for example, the standard operating procedure for a particular organizational group may be set by a group of administrators of the organization. For example, the organization management platform enables the creation of a steering committee comprising senior employees selected from within each of the organizational groups who formulate a preliminary template for the creation of the rules via the GUI based on an ethical framework of the organization and the target goal criteria for the organization. The organization management platform provides a configurable dashboard display interface using which the employees associated with a particular organizational group can add new regulations to the standard operating procedure. Consider an example where the average attendance of the employees of a particular organizational group has fallen below a threshold value, and the organizational group is required to meet a deadline in accordance with a service level agreement set for the employees of the organizational group. The organization management platform monitors the attendance of the employees and transmits a notification message to all the employees of the organizational group via a configurable dashboard display interface on the GUI. The employees of the organizational group may then take part in an online meeting triggered by the organization management platform to modify the rules for the organizational group by reducing the number of allowed holidays or canceling the allotted holidays for each of the employees of the organizational group. The organization management platform restricts access of the rules for modification to only a set of authorized employees by setting filters on the GUI based on a profile of the employee. In another example, the organization management platform provides options for electronic voting and setting electronic reminders on the GUI, for example, to record approval by all the employees of the particular organizational group for a particular rule set by the organizational group. Therefore, the organization management platform provides a framework for self-governance by the employees within each of the organizational groups.

In an embodiment, the organization management platform provides one or more configurable dashboard display interfaces on the GUI for transmitting and/or receiving notifications of status of performance of the tasks associated with the selected organizational groups from one or more of the employees to the other employees. For example, the organization management platform transmits notification messages querying the status of performance of the tasks, and receives notification messages replying to the queries, as part of a chat conversation initiated among the employees on the configurable dashboard display interfaces on the GUI. In an embodiment, the organization management platform maps the acquired tasks to calendar events, tracks the calendar events associated with the organizational groups, transmits requests for performing the tasks mapped to the calendar events to each of the employees in each of the selected organizational groups, and transmits reminder notifications of the calendar events periodically to each of the employees in each of the selected organizational groups. For example, the organization management platform monitors a morning operating rhythm and an evening operating rhythm for each of the tasks associated with each of the organizational groups. The operating rhythm is, for example, a recurring calendar event, for example, a set of team meetings with a predefined meeting agenda and time duration, initiated to evaluate the performance of the organizational group within a particular time period. For example, the operating rhythm may be set every day, that is, a daily operating rhythm, every month, which is, a monthly operating rhythm, etc. The morning operating rhythm comprises, for example, an evaluation of projects that had the maximum number of errors indicated in red on the GUI during the morning. The evening operating rhythm comprises, for example, the evaluation of projects at the end of the day.

The organization management platform measures 106 performance of the tasks by each of the employees in each of the selected organizational groups, based on the acquired rules and performance criteria. The performance criteria are set based on the individual key result areas set for the employees. The performance criteria for measuring the performance of the employees comprise, for example, quality of work delivered by each employee, attendance of each employee, etc. The organization management platform verifies compliance of an employee with the acquired rules, for example, the standard operating procedures defined for the organizational group. The organization management platform measures the performance of the tasks in accordance with a balanced scorecard system and the individual key result areas. The organization management platform uses the balanced scorecard system as a measurement tool for measuring the performance of the employee and for setting additional individual key result areas for the employees. The balanced scorecard system is guided by the overall objectives of the organization, that is, by the acquired target goal criteria. The balanced scorecard system combines financial and non-financial performance indicators for measuring the performance of the employee with reference to the organization and aligns a working routine of the employee towards the overall standards of the organization. The balanced scorecard system may however introduce a rigid adherence to fixed objectives and the possibility of subjective bias. In order to introduce objectivity to a subjective evaluation introduced by the balanced scorecard system, the organization management platform evaluates the individual key result areas for each employee measuring, for example, attendance of the employee, conformance with the acquired rules associated with the organizational group, the individual targets achieved, the performance of the employee across multiple organizational groups, etc. Therefore, the organization management platform computes a performance indication score using the balanced scorecard system and the individual key result areas for the employee.

Furthermore, the organization management platform selectively allows creation, updation, deletion, and access of the organizational groups based on a profile of a user, for example, an employee seeking access to the organizational groups. The organization management platform, for example, applies content filters based on a mapping between the user account and the access rights of the user. For example, when the organization management platform determines that the user is a regular user such as a junior employee of the organizational group, the organization management platform allows the employee access to only some of the organizational groups and some of the configurable dashboard display interfaces associated with each of the organizational groups. Furthermore, the organization management platform allows the employee to initiate chat conversations with other employees of the organizational group, update knowledge bases of the organizational group, etc., via the GUI. The organization management platform denies access to the regular user for creating a new organizational group, deleting a particular organizational group, viewing notification messages shared among some of the employees of the organizational group, requesting permission to add or remove employees of the organizational group, etc.

When the organization management platform determines that the employee is a “power user” or an authorized administrator, for example, a senior employee, the organization management platform allows the employee to access a select set of organizational groups, delete the organizational groups, delete notification messages associated with the organizational groups, etc. When the organization management platform determines that the employee is a “super user”, the organization management platform allows the employee to have complete access to all the organizational groups for creating or deleting any of the organizational groups, deleting notification messages associated with any of the organizational groups, etc. Furthermore, the organization management platform permits the super users to add an employee to or remove an employee from an organizational group. The organization management platform, for example, configures templates for creating and deleting organizational groups with password encryption mechanisms mandating employees to enter authorized passwords. The organization management platform enables authorized employees to add new configuration settings or modify preconfigured settings for permitting or denying access, for example, to configurable dashboard display interfaces on the GUI, confidential technical information, etc., on the organization management platform. For example, the organization management platform allows an authorized employee to set information access filters based on a profile status of a user, for example, “Employee”, “Manager”, “Client”, etc., to permit or deny access, for example, of one or more configurable dashboard display interfaces on the GUI, confidential technical information, etc., on the organization management platform to the user.

In an embodiment, the organization management platform selectively displays information on progress of the tasks performed by each of the employees in the selected organizational groups on one or more configurable dashboard display interfaces on the GUI, to the employees and the clients of the organization based on a profile of each of the employees and the clients of the organization. The organization management platform controls access of the information on the progress of the tasks based on whether the user is a regular employee, a power user, a super user, etc. For example, the organization management platform configures separate dashboard display interfaces for displaying the service level agreements between the organization and the clients, and the organization and the employees of the organization.

The organization management platform allocates 107 one or more units of electronic currency to each of the employees in each of the selected organizational groups based on the measured performance. As used herein, the term “electronic currency” refers to a unit that indicates performance of a user, for example, an employee and that can be exchanged by the user for receiving an item of value. The units of electronic currency comprise, for example, points, points redeemable for cash, points redeemable for an item of value, points redeemable for a promotion, a stock share in the organization, a job transfer within the organization, that is, an internal job transfer, coupons, special discounts on products and/or services of the organization, etc., and any combination thereof. Therefore, the employee can, for example, perceive working for the organization as equivalent to participating in a game, and accruing units of electronic currency and receiving a promotion as equivalent to reaching the next level of the game. The units of electronic currency accrued by an employee create a valuation for the virtual avatar or the employee in the organization for the tenure of the employee in the organization or in the life of the virtual avatar in the organizational group. This helps the employee represented by the virtual avatar in the virtual social network environment to grow to different levels in the organization and even get promoted.

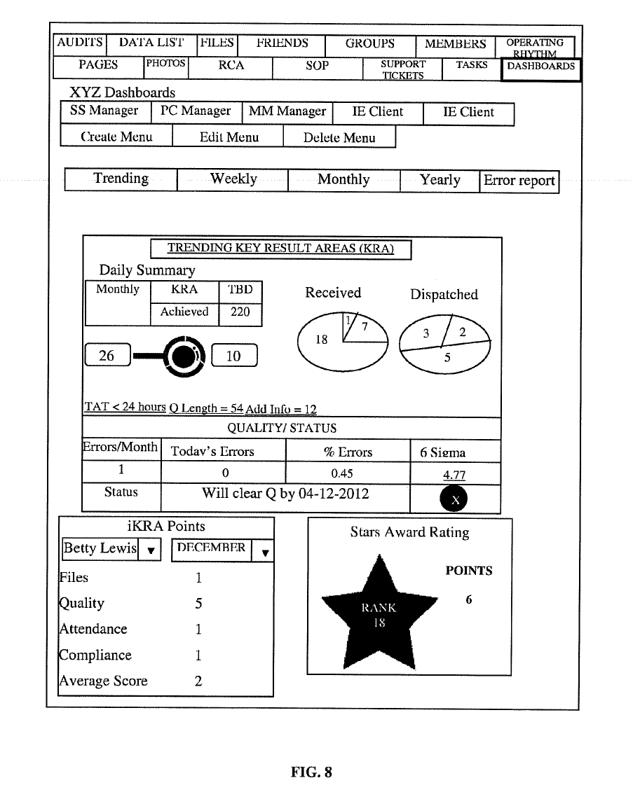

In an embodiment, the organization management platform assigns a performance indication score that translates to a predetermined number of units of electronic currency. For example, the organization management platform computes a performance indicator score by applying a statistical algorithm incorporating the current performance of a particular employee in each of the assigned tasks and the performance of the employee in previous tasks of the organizational group to record a differential improvement in the performance of the employee. The performance indication score is, for example, a “star award rating” which is displayed on the GUI as exemplarily illustrated in FIG. 8. Furthermore, the organization management platform computes a relative performance indication score across the employees of the organizational group. The performance indication score is based on performance parameters, for example, completion of a particular task within an assigned date of completion, a proactive initiation and completion of a particular task external to the assigned tasks of an employee, leadership skills of the employee in organizing and guiding less experienced employees within the organizational group towards completing a particular task, etc. The organization management platform assigns each of the performance parameters with a particular weight for computation of the performance indication score.

The organization management platform accumulates the units of electronic currency allocated to each of the employees across the selected organizational groups in an incentive account associated with each of the employees. The incentive account operates as an online bank for the employee within the organization. The incentive account allows senior management of the organization or supervisors of each of the organizational groups to track progress of the employees in each organizational group and through the organization using the incentive account. In an embodiment, the organization management platform allocates a positive electronic currency for a successful performance of the tasks in accordance with the acquired rules to fulfill the acquired target goal criteria of the organization, and allocates a negative electronic currency for a failed performance of the tasks in accordance with the acquired rules to fulfill the acquired target goal criteria. Consider an example where an employee adds a script for automating a sequence of testing steps that improves the time for performing testing on a software module. The organization management platform monitors the performance of the employee in the virtual social network environment and allocates a positive electronic currency for the employee for complying with the rules set by the organizational group along with improving the quality of performance of the organizational group. Consider another example where an employee has bypassed some of the mandatory validity checks while performing the testing of a particular software module and has not complied with the associated standard operating procedure. On receiving a notification message from an authorized entity, the organization management platform deducts a predetermined number of units of electronic currency from the incentive account of that employee or adds negative electronic currency to the incentive account of the employee. The usage of a positive electronic currency and a negative electronic currency enables employees working in the organization to view working for the organization, for example, as being part of a virtual game.

In an embodiment, the organization management platform allocates a greater number of units of electronic currency to each of the employees in each of the selected organizational groups when each of the employees performs one or more other tasks in one or more of multiple other organizational groups. Consider an example where the minimum number of units of electronic currency allocated for performing tasks T1, T2, and T3 in each of the organizational groups G1, G2, and G3 respectively is C1, C2, and C3 respectively. Consider an employee who is a part of the organizational group G1 and has been assigned task T1. In addition to performing task T1 for group G1, if the employee associated with the organizational group G1 performs the tasks T2 and T3 for the organizational groups G2 and G3 respectively, the organization management platform allocates a bonus of C4 units of electronic currency in addition to the C1, C2, and C3 units of electronic currency that the employee is entitled to receive. The organization management platform configures the bonus units of electronic currency, for example, based on criticality and a time duration assigned for the tasks T2 and T3 performed by the employee. The bonus units of electronic currency may be set by the senior management of the organization via the GUI of the organization management platform. Furthermore, the organization management platform monitors a total number of the allocated units of electronic currency accrued by each of the employees over a predetermined duration of time for tracking progress of the employees.

In an embodiment, the organization management platform generates a virtual environment for virtual avatars to compete with one another, for example, for successfully completing a task within the shortest period of time, for online gaming events, etc. The organization management platform records and monitors the performance of the virtual avatars over a predetermined duration of time. Therefore, if the virtual avatars complete tasks in line with the key result areas defined for the organization, the organization management platform allocates one or more units of electronic currency for the virtual avatars. Furthermore, in an example, the organization management platform simulates a virtual game environment with multiple levels that are configured to allow employees to get to higher levels based on the quality of tasks and the number of tasks completed by each of the employees. In an embodiment, the organization management platform dynamically transforms the selected virtual avatar of each of the employees, when each of the employees accrues a predetermined number of the allocated units of electronic currency. In an example, the organization management platform graphically transforms the virtual avatar to visually represent the accruement of a predetermined number of units of electronic currency. For example, an icon representing a virtual avatar of an employee who reached the predetermined number of units of electronic currency or the virtual avatar of an employee with the maximum number of units of electronic currency at the end of a predefined duration of time, is graphically accentuated with a crown, a medallion, gold stars, or an inscription stating “Star employee” or “Leader”, etc. Therefore, the organization management platform advertises employees with the highest number of units of electronic currency as leaders or role models of the organization.

In an embodiment, the organization management platform allocates one or more units of electronic currency to each of the employees in each of the selected organizational groups based on a weight assigned to each of the acquired tasks and each of the organizational groups. For example, when the quality of a particular product or timely completion of a task is a concern for an organizational group, the organizational group increases the weights assigned to the tasks of the organizational group such that the employees can be reoriented towards the needs of the organizational group. This facilitates employees outside the organizational group to volunteer for the tasks associated with that particular organizational group. The organization management platform assigns the weights based on predetermined weighting criteria, for example, a required quality of performance of a task, a required adherence to timing constraints such as an end date defined for completion of a task defined by a service level agreement for the employee, etc. Furthermore, the organization management platform assigns the weights according to the individual key result areas for the employee, for example, daily attendance of the employee, a level of competence reached by the employee in multiple organizational groups, etc. The organization management platform enables changing of the weights on the KRAs to allow the organization to react quickly to the needs of the organization.

In an embodiment, the organization management platform monitors progress in the performance of the tasks by each of the employees in each of the selected organizational groups over a predetermined duration of time, for example, by tracking the allocated units of electronic currency accrued by each of the employees over the predetermined duration of time. In another embodiment, the organization management platform monitors relative progress of each of the organizational groups based on the performance of the tasks by each of the employees associated with each of the organizational groups over a predetermined duration of time. For example, the organization management platform retrieves the service level agreements defined for each of the organizational groups from a database management system of the organization management platform. The organization management platform compares the performance of the tasks by the employees in each of the organizational groups in accordance with the service level agreements defined for each organizational group. In an example, if the service level agreement defines a required reduction in the number of errors of a software code, the organization management platform determines weekly progress in the reduction of the number of errors achieved by the particular organizational group and compares the determined reduction with the service level agreement.

The organization management platform, for example, automatically imports statistical reports, status notification message files, updated data files, logs, etc., from local databases for each of the organizational groups via the communication network over a predetermined duration of time. The predetermined duration of time is, for example, a week, a month, a year, etc. The organization management platform compares the progress of the employee or the overall organizational group in terms of the deliverables delivered against the service level agreements defined for the organizational group. The organization management platform then generates a report detailing the key result areas for the organization and the comparative progress made in each of the key result areas. In an embodiment, the organization management platform manages competitions between the organizational groups, where a winning organizational group is determined based on the performance of the tasks by each of the employees in each of the organizational groups over a predetermined duration of time.

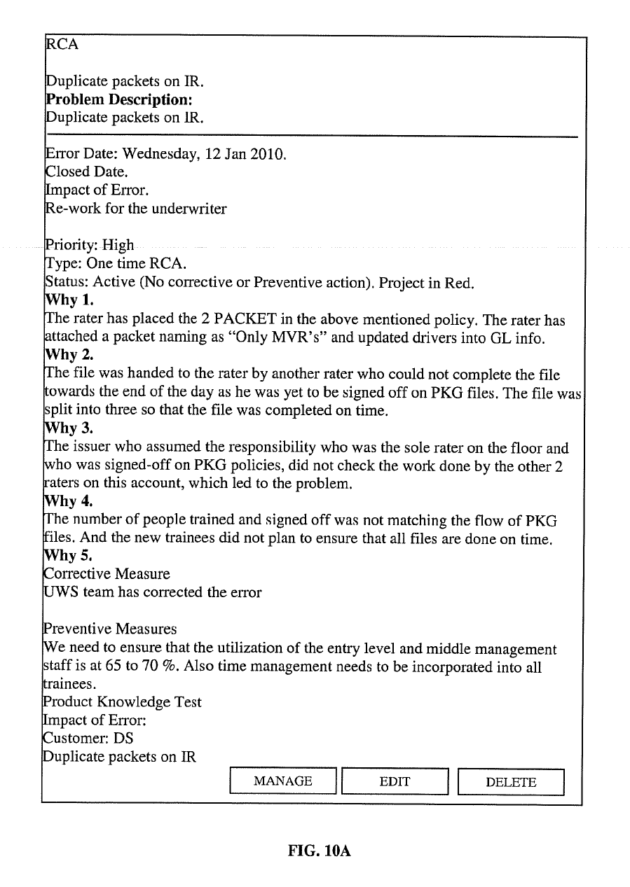

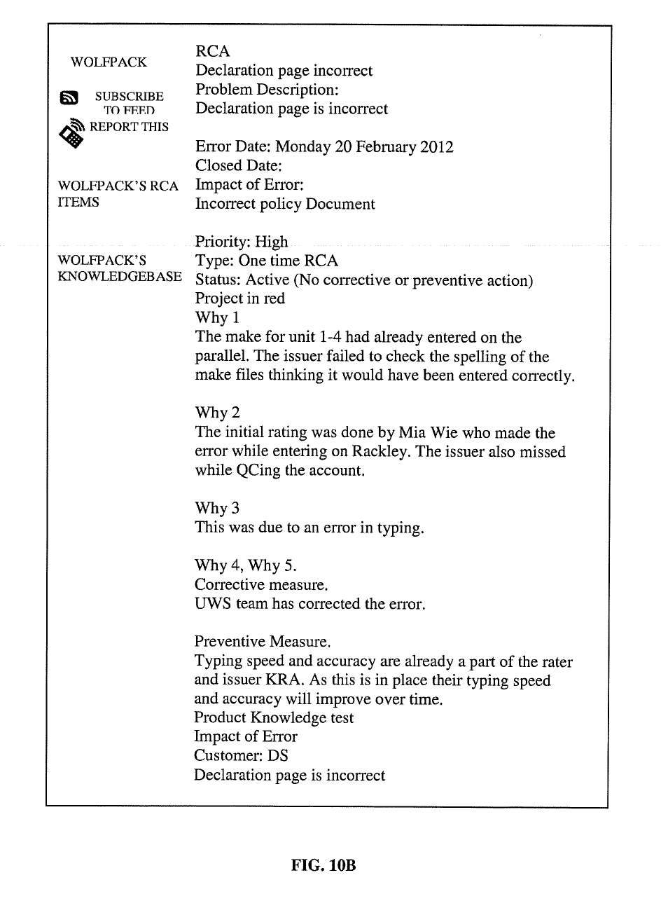

In an embodiment, the organization management platform performs a root cause analysis for identifying one or more causes of failure in performing the tasks, and for identifying the organizational groups responsible for the identified causes of failure. The organization management platform automatically updates the acquired rules for the performance of the tasks, for example, standard operating procedures used by the organizational group for overcoming the identified causes of failure. The term “root cause analysis” refers to a methodical process of analyzing a problem, determining errors in a working procedure, and suggesting recommendations for ensuring corrections to the problem. The organization management platform thereby enables the adoption of preventive measures by the organizational group for avoiding a recurrence of problems detected during the root cause analysis. In an embodiment, the organization management platform generates a series of linked queries iteratively for identifying the causes of failure in performing the tasks, and transmits the generated series of linked queries to the organizational groups via the GUI for obtaining responses that identify the causes of failure from the employees in each of the organizational groups. For example, the organization management platform is configured to operate on a “5 Why” procedure to evaluate the identified causes of the failure as disclosed in the detailed description of FIGS. 10A-10B.

The organization management platform notifies the identified causes of failure to each of the employees of the organizational groups associated with the identified causes of failure. Furthermore, the organization management platform generates and tracks completion of a product knowledge test by each of the employees of the organizational groups associated with the identified causes of failure via the GUI for overcoming the identified causes of failure. Furthermore, the organization management platform updates a knowledge base accessible to all the employees of the organization, for example, with solutions for the identified causes of failure, preventive measures to avoid failure, etc. The knowledge base stores, for example, technical information, compliance regulations, etc., that is to be referred by the employees for performing the tasks of the organizational group. In an example, the organization management platform stores a task performance file in the knowledge base that details solutions for the identified causes of failure, preventive measures to avoid failure, changes to the compliance regulations, etc. The employees access the knowledge base of the organization management platform over the communication network in the virtual social network environment. In an embodiment, the organization management platform generates recommendations for successful performance of the tasks and notifies the generated recommendations to each of the employees in the selected organizational groups via the GUI. Consider an example of a root cause analysis where the organization management platform determines that a design of a particular product is not in accordance with compliance regulations set by a standardized technical body. The organization management platform identifies the areas of non-compliance and generates and renders a report to each of the employees of the organizational group recommending corrections to a specification of the design, the standard operating procedures, etc., of the organizational group via the GUI for complying with the compliance regulations set by the standardized technical body.

In an embodiment, the organization management platform performs a behavioral analysis of each of the employees in the selected organizational groups based on an analysis of conformance of each of the employees with the acquired rules, and a number of the allocated units of electronic currency accrued by each of the employees for each of the acquired tasks, and an analysis of interactions among the employees in the organization. The organization management platform extracts the interactions from one or more configurable dashboard display interfaces on the GUI for performing the behavioral analysis. For example, the organization management platform records the number of tasks successfully completed for a particular organizational group by an employee within a predetermined duration of time. Furthermore, the organization management platform analyzes the interactions made by each employee with other employees on technical issues in meetings, chat conversations on non-technical topics, the tasks proactively initiated by the employee for improving the performance of the organizational group, attendance of the employee in technical seminars and subjects of these seminars, the tasks for which the employee has accumulated a larger number of units of electronic currency, willingness of the employee to take up a new responsibility within the organization, participation of the employee in team activities, etc. The organization management platform then applies behavior prediction models to determine whether an employee is inclined towards a particular technical area in the organization, create a behavioral profile of the employee, for example, whether an employee is an introvert, an extrovert, an entrepreneurial extrovert, a leader, etc. The organization management platform applies behavioral analysis over a predetermined duration of time to leverage short term variations in the behavior of the employee. In another example, the organization management platform provides inputs to a manager of the organizational group for a manual analysis of interests and behavior of each of the employees of the organizational group, for example, to allow the manager to assign additional responsibilities or tasks, determine allocation of units of electronic currency, offer a promotion, etc. The organization management platform generates a report summarizing the behavioral analysis and transmits the report to a manager associated with the organizational group via the GUI.

FIG. 2 exemplarily illustrates a screenshot of a graphical user interface (GUI) provided by the organization management platform, displaying links to templates for managing organizational groups associated with each of the employees. The organization management platform provides a list of previously created organizational groups within the organization to enable each of the employees in the organization to select one or more organizational groups and place a request for entry into each of the selected organizational groups. The employees of the selected organizational group may review each request and permit entry of a requesting employee into the selected organizational group, subsequent to which the employee is registered into the selected organizational group. As exemplarily illustrated in FIG. 2, the GUI displays a list of organizational groups created by a particular employee on activating, for example, a “My Owned Groups” link on the GUI and a list of organizational groups of which the employee is a member although the employee has not created that particular organizational group on activating, for example, a “My Groups” link on the GUI. In an embodiment, the organization management platform provides a “Group Invitations” link on the GUI for allowing an employee to invite another employee in the organization into an organizational group. The organization management platform generates an invitation request message and transmits the invitation request to the employee to be invited via an electronic mail, a chat invite, etc., over the communication network. The organization management platform also provides selective access to all the organizational groups created on the organization management platform on activation of, for example, an “All Site Groups” link on the GUI, and to a knowledge base of the organization management platform on activation of, for example, a “Knowledge base” link on the GUI.

In an embodiment, the GUI provides links to templates, for example, a configurable file, a script, a graphical user interface template, etc., using which an authorized employee can enter inputs such as a name of an organizational group, rules for performing tasks associated with a particular organizational group, options available to the employees of the organizational group for accessing technical information, work status information, etc.

FIG. 3 exemplarily illustrates a screenshot of the graphical user interface (GUI) provided by the organization management platform, displaying a virtual avatar selected by an employee of an organizational group and characteristic profile information associated with the virtual avatar. A visual representation of the virtual avatar of the employee is displayed, for example, as a comic character “Ferb” as exemplarily illustrated in FIG. 3. The organization management platform provides each of the employees or the clients of the organization with a unique user account and allows each of the employees or the clients of the organization to select a virtual avatar to represent them. The user account stores profile information of the employee or the client of the organization. The organization management platform provides an “edit profile” link on the GUI to allow an employee or a client to select a particular virtual avatar and edit his/her profile information. The organization management platform provides each employee with a profile page associated with their respective user account on the GUI displaying links for audits, a data list, files accessible to the employee, friends of the employee, the organizational groups of which the employee is a member, contact information of the other members of the organizational group associated with the employee, access to operating rhythms, pages, root cause analysis (RCA) reports, standard operating procedures (SOPs) defined by or for the employee, tasks assigned to the employee, the configurable dashboard display interfaces accessible to the employee, etc.

FIGS. 4A-4B exemplarily illustrate screenshots of a graphical user interface (GUI) provided by the organizational management platform, displaying acquisition of rules for a task to be performed by an organizational group and a corresponding notification on the status of the task. As exemplarily illustrated in FIG. 4A, the rules acquired by the organization management platform are, for example, standard operating procedures on invoicing defined by one or more employees of an organizational group created for managing finance of the organization. The standard operating procedure defines, for example, process steps for recording the number of hours worked per employee and for generating an invoice accordingly. The standard operating procedure is defined by a version, a start date, a review date, etc. The employees of the organizational group are expected to comply with the defined standard operating procedure. The organization management platform allows employees of the organization to access the defined standard operating procedures on the GUI. Furthermore, the organization management platform allows employees of the organization to initiate a review or an online discussion on the standard operating procedures for each of the organizational groups on the GUI as exemplarily illustrated in FIG. 4B. For example, an employee John has posted a comment on the standard operating procedure for invoicing by the organization and provides a notification on the status of the task of invoicing on the GUI as exemplarily illustrated in FIG. 4B.

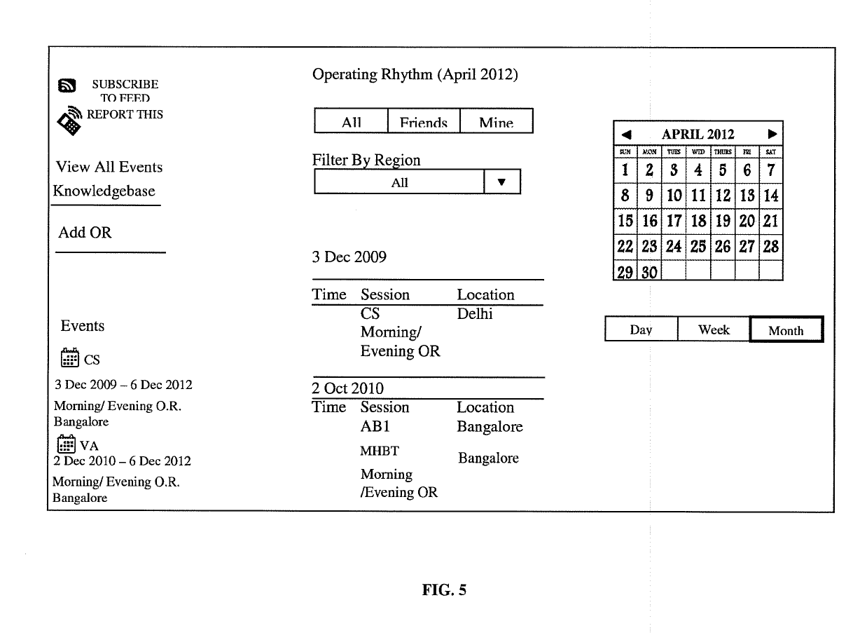

FIG. 5 exemplarily illustrates a screenshot of a graphical user interface (GUI) provided by the organizational management platform, displaying initiation of an operating rhythm for an organizational group. As exemplarily illustrated in FIG. 5, the GUI indicates an operating rhythm for the month of April. The screenshot displays mapping of acquired tasks to calendar events, the location and time associated with each of the calendar events, etc. The operating rhythm is initiated to evaluate the performance of the organizational group within a particular time period as disclosed in the detailed description of FIG. 1.

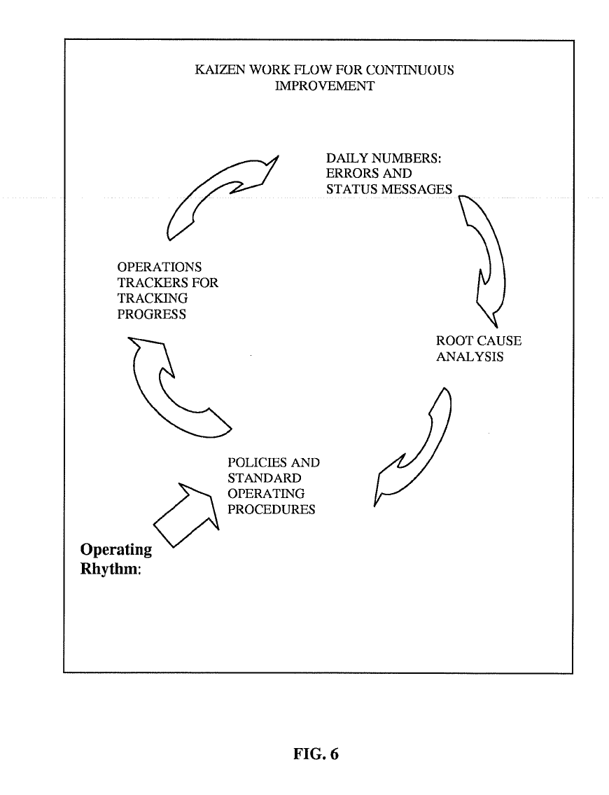

FIG. 6 exemplarily illustrates a schematic flow diagram comprising the steps performed by the organization management platform for managing an organization in a virtual social network environment. The organization management platform applies, for example, a Kaizen work flow for continuous improvement of processes, for example, in manufacturing, engineering, game development, business management, etc. The work flow applied by the organization management platform on initiation of an operating rhythm comprises, for example, acquiring policies and standard operating procedures and then reviewing changes to the policies and the standard operating procedures for the duration of the operating rhythm. The organization management platform then tracks the progress of the employees of each of the organizational groups for the duration of the operating rhythm. For example, the organization management platform sets up a query management system that automatically queries each of the organizational groups on the status of progress of the individual tasks such as status of completion of a design specification document, completion of development of a software code, number of errors captured during testing of the software code, completion of updates to the software code, etc. Furthermore, the organization management platform transmits periodic reminder messages or configures pop-up alerts as reminders for each of the employees. The organization management platform then collects the responses on the daily statistics capturing, for example, the number of errors or failures in the implementation of a particular task, status changes on completion of a particular task, etc. The organization management platform performs a root cause analysis to identify the causes of failure of completion of each task as disclosed in the detailed description of FIGS. 10A-10B. The organization management platform then updates the policies and the standard operating procedures to overcome the identified causes of failure, thereby completing the work flow. The organization management platform repeats the steps of the work flow through the course of the operating rhythm.

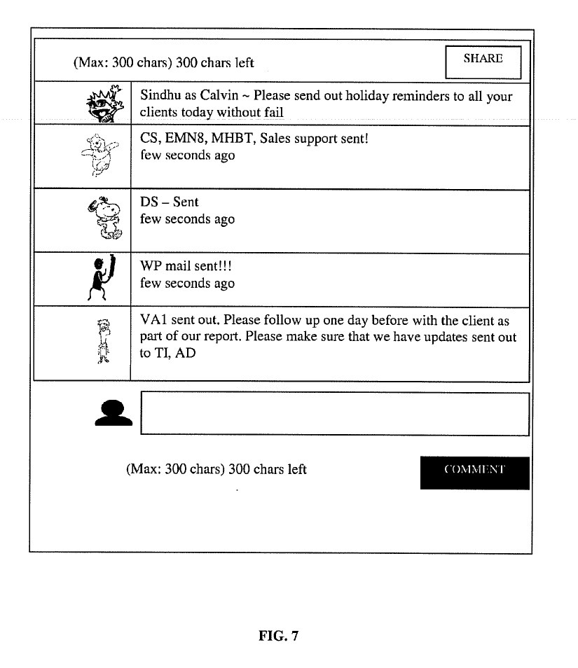

FIG. 7 exemplarily illustrates a screenshot of a configurable dashboard display interface provided on the graphical user interface (GUI) by the organization management platform, displaying interactions among employees of an organizational group in the virtual social network environment. The organization management platform allows employees represented by their respective virtual avatars in an organizational group to share notification messages with the other employees of the organizational group. An employee in the organizational group may transmit a request message to another employee in the organizational group, for example, to send out holiday reminders to all clients of the organization at a specified date and/or time, to follow up with clients, to transmit updates to clients, etc., via the GUI. The other employees in the organizational group may also transmit response messages to the requesting employee on the status of implementation of the requests via the GUI.

FIG. 8 exemplarily illustrates a screenshot of a configurable dashboard display interface provided on the graphical user interface (GUI) by the organization management platform for displaying status and trends in performance of tasks by employees in an organizational group. The organization management platform configures the dashboard display interface, for example, based on inputs received from the employees of the organizational group. The inputs received from the employees comprise, for example, requests for displaying progress of an organizational group in achieving the tasks based on a particular key result area such as “Quality”, “Status”, “Timely delivery”, etc., defined for the organization, requests for displaying recently added corrections for overcoming a particular cause of failure, etc. The dashboard display interface displays trends on the progress of tasks associated with a particular key result area captured by the organization management platform. The dashboard display interface displays a daily summary of the key result areas addressed by the organizational group, an error status of the organizational group, etc. The organization management platform generates, for example, a six sigma score that measures quality of performance of each of the employees of the organizational group. Consider an example where the organization management platform accesses a configurable dashboard display interface associated with a particular organizational group to measure work performed for a project and performance of each employee in meeting the key result areas defined for the organization. Consider, for example, that the key result areas comprise quality and timely delivery of a product. Therefore, performance of each employee in meeting each of the key result areas are measured based on defects recorded for each of the tasks, whether the tasks were performed on time or delayed, etc. The organization management platform generates a six sigma score based on the number of errors or the total delay recorded for the completed task for the employees of the organizational group working on the task.

Furthermore, the dashboard display interface displays a customized performance window, also referred to as an employee performance interface, for each individual employee that indicates an individual breakup of the performance indication score for each performance parameter constituting the performance criteria. For example, the employee performance interface displays a qualitative score for files worked on by an employee “Betty Lewis”, a score assigned for the quality of performance of a task, a score assigned for regularity of attendance of the employee, and a score assigned for compliance with the rules, that is, the standard operating procedures set for the organizational group. The average score received by Betty Lewis is recorded by the organization management platform. Furthermore, the employee performance interface displays the total number of units of electronic currency, for example, in the form of star reward points acquired by Betty and the star award rating received by Betty in comparison with the other employees of the organizational group. The dashboard display interface is configured to selectively display service level agreements, progress on the completed tasks, etc., based on whether a user viewing the dashboard display interface is a client of the organization, an employee of the organization, etc. The employees may also access the weekly, monthly, yearly progress against the service level agreements on the dashboard display interface. The organization management platform tracks the daily progress of each of the organizational groups and generates a report.

FIG. 9 exemplarily illustrates a screenshot of a graphical user interface (GUI) provided by the organization management platform, displaying an escalation matrix configured by the organization management platform for each of the employees. The escalation matrix on the GUI provides access to a list of employees to be contacted for escalating an issue. The escalation matrix comprises a series of virtual avatar icons representing these employees. The organization management platform acquires a request for escalation from an employee and then waits for a selection of a virtual avatar icon in the escalation matrix. On receiving a selection of a particular virtual avatar icon in the escalation matrix from the employee, the organization management platform generates a escalation notification message and transmits the escalation notification message to the employee associated with the particular virtual avatar icon. Furthermore, the organization management platform stores the escalation request registered by the employee against the virtual avatar of the employee and maintains a mapping between the employee triggering the escalation and the employees to whom the escalation request is transmitted in the database management system of the organization management platform. The organization management platform de-escalates the escalation request after receiving an input from the employees who were notified of the escalation.

In another example, the organization management platform automatically transmits escalation notification messages to one or more virtual avatars listed in the escalation matrix on determining that criticality of a particular issue is set to “Very Critical”. Furthermore, in another example, the organization management platform retrieves availability status of each of the virtual avatars listed in the escalation matrix and transmits the escalation notification messages to other virtual avatars when the organization management platform determines that the availability status of a particular virtual avatar is set to “Unavailable”. The organization management platform first tracks the calendar events of each of the employees of the organizational group to be notified, for obtaining their availability status, and then transmits the escalation notification message to an employee on confirming the availability of the employee.

The screenshot of the GUI exemplarily illustrated in FIG. 9 also displays a trend window that indicates the trends and status of the tasks associated with some of the key result areas. In this example, the key result area is “Quality/Status”. The quality of the deliverables is determined based on the number of errors reported for the deliverables. The timely delivery of a deliverable is based on the number of “days out”, that is, the number of days within which a particular key result area for a project is achievable by the organizational group and the deliverable made available to a client. Furthermore, organization management platform details a daily turnaround time (TAT) of each of the tasks, the status of the tasks in terms of the errors reported for a particular month, errors reported for a particular day, etc. The organization management platform assigns a separate color code marking the status of the tasks that are yet to reach a desired target.

FIGS. 10A-10B exemplarily illustrate screenshots of the graphical user interface (GUI) provided by the organization management platform, displaying reports of a root cause analysis (RCA) performed by the organization management platform for identifying causes of failure reported by an organizational group. As exemplarily illustrated in FIGS. 10A-10B, the organization management platform is configured to generate queries for identifying the causes of failure, identify the organizational group to which the queries need to be directed, and obtain responses to the queries based on which a subsequent query is generated. The organization management platform receives a base query from an employee based on which the organization management platform generates a series of queries and records the responses to the queries from the employees in each of the organizational groups a predetermined number of times. The organization management platform then generates a preliminary root cause analysis report based on the recorded queries and responses. The organization management platform identifies potential organizational groups to which the queries need to be directed, for example, by performing a term-by-term comparison of each query with a preconfigured dictionary of terms associated with each of the organizational groups. In an embodiment, the organization management platform acquires manually generated queries from the employees of a organizational group, for example, using the “5 Whys” methodology via the GUI as exemplarily illustrated in FIG. 10A, for extracting a cause and effect relationship for each of the failures. The organization management platform collects the queries and directs the queries to a target organizational group.

In an embodiment, the organization management platform performs a root cause analysis by extracting patterns from the identified causes of failure. The organization management platform maps each of the patterns with the queries previously generated for subsequently obtaining internal causes of failure. The organization management platform stores the identified causes of failure as training data in a training database in the database management system and analyzes the identified causes of failure accumulated in the training database for recognizing problem patterns. If the organization management platform detects a particular problem pattern, the organization management platform automatically generates a query based on the mapping stored in the training database. In an example, FIG. 10B exemplarily illustrates a report on a root cause analysis performed for a statement of failure reading “Declaration page is incorrect”. The preliminary cause for the failure states that spellings of the make files were entered incorrectly. The subsequent queries relate to why the raters performed their work incorrectly, why the spellings were typed incorrectly, etc. The organization management platform collects the responses to each of the queries from one or more organizational groups. The organization management platform generates a report based on the queries and the responses to the queries. The report comprises a “corrective measure” stating how the failure has been rectified and a “preventive measure” stating how the failure could have been avoided. Furthermore, based on the criticality of the failure and the scope of the failure, the organization management platform generates a product knowledge test to be completed by the employees of the organizational group responsible for the failure.

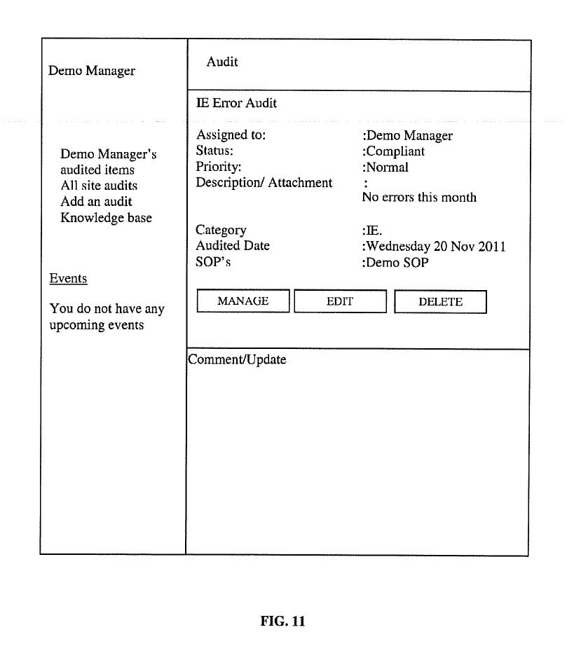

FIG. 11 exemplarily illustrates a screenshot of a graphical user interface (GUI) provided by the organization management platform, displaying an audit report generated by the organization management platform. The organization management platform generates an audit report based on audit records acquired from a particular organizational group and displays the audit report on an audit page on the GUI. A manager can manage audits, view audit reports, provide comments or updates, etc., on the audit page on the GUI. The organization management platform generates an audit report, for example, for an error audit as exemplarily illustrated in FIG. 11. The audit report provides information on an individual employee or an organizational group to whom the audit was assigned, a status of compliance, a link to a standard operating procedure that needs to be compliant with the established compliance standards, etc. In an embodiment, the organization management platform performs an audit of data files, configuration files, etc., associated with each of the organizational groups to verify compliance with established compliance standards. The organization management platform is configured to perform a comparison between a predetermined template comprising configuration parameters defined according to the compliance standards, and the data files, configuration files, etc., generated by the organizational group. The organization management platform then generates a report detailing number of configuration parameters that are compliant and/or non-compliant, areas of non-compliance, recommendations for achieving compliance, etc. In an embodiment, the organization management platform generates an audit trail recording the sequence of activities performed by each of the organizational groups.

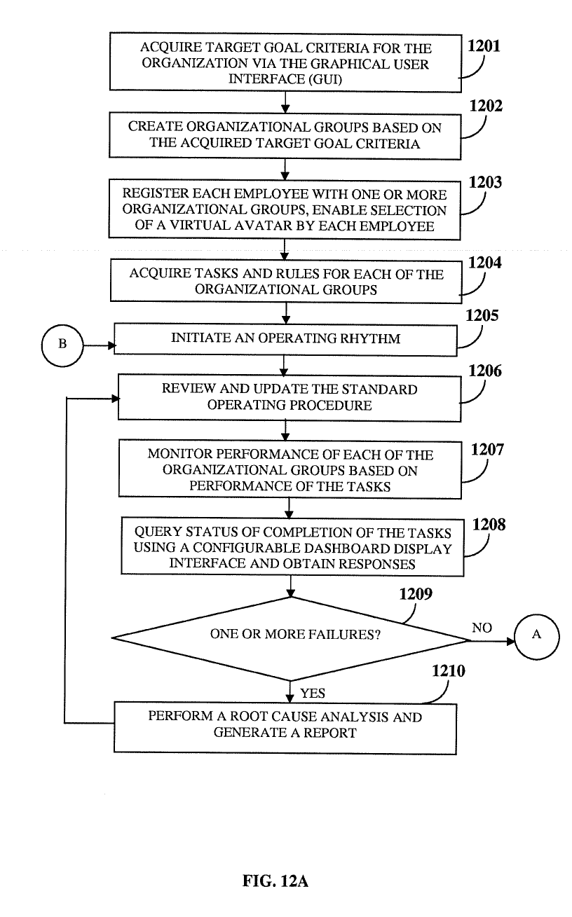

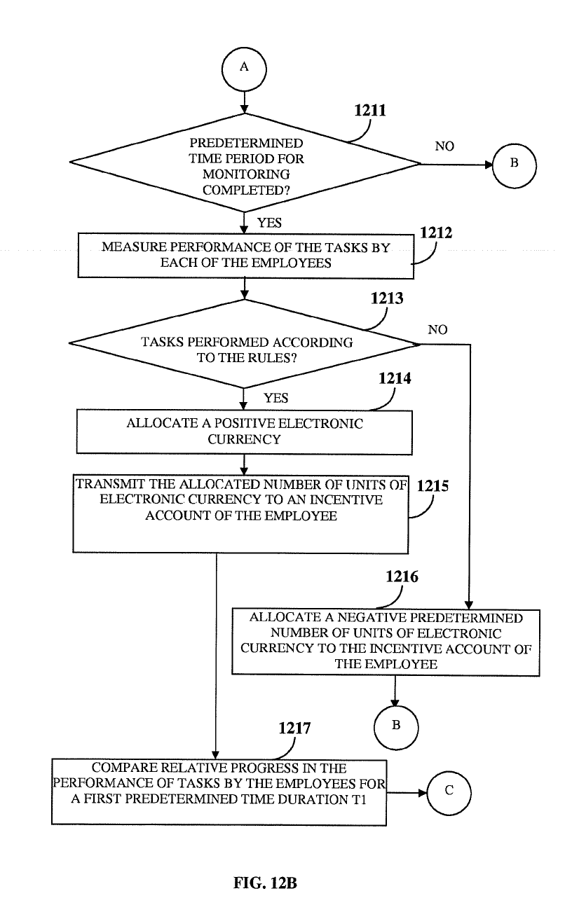

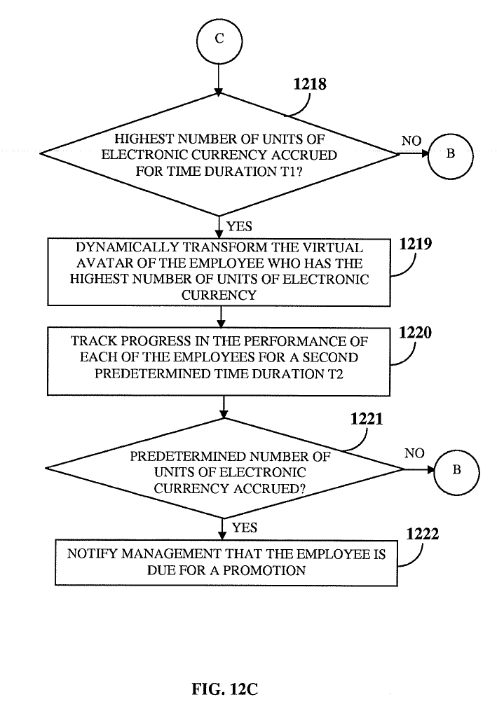

FIGS. 12A-12C exemplarily illustrate a flowchart comprising the steps for managing an organization in a virtual social network environment. The organization management platform acquires 1201 target goal criteria for the organization via the graphical user interface (GUI) provided by the organization management platform. The target goal criteria comprise, for example, key result areas for the organization. The key result areas are, for example, improving quality of a product delivered by the organization, improving knowledge areas and competence of employees in multiple organizational groups, improving communication with clients of the organization, etc. The organization management platform creates 1202 multiple organizational groups based on the acquired target goal criteria. The organization management platform allocates particular key result areas for each of the organizational groups. In this example, the organizational groups comprise an assimilation group, a communication group, a learning group, a leadership group, a standards group, and a fun group.

The assimilation group comprises newly recruited employees of the organization and alumni of the organization. The key result areas for the assimilation group are, for example, inducting the newly recruited employees into the organization and ensuring assimilation of an organizational structure, ethical values, objectives, etc., of the organization. The key result area for the communication group is to develop an ability of an employee to communicate effectively with clients of the organization, peer employees, senior management of the organization, etc., during telephonic conversations, face-to-face sessions, group sessions, etc. The key result area for the communication group is defined, for example, based on a problem that employees may not have basic written, oral and presentation skills. The key result areas for the learning group are, for example improving knowledge of an employee and developing competence of an employee. The key result area for the leadership group is, for example, preparing employees of each of the organizational groups to lead the organizational groups, teams, projects, and eventually the entire organization. The key result area for the standards group is, for example, setting standards for the organization compliant with established global standards for an improved quality of a service or a product delivered by the organization. The key result area for the fun group is, for example, development of a cross-functional team building platform that enables interactions between the employees of multiple organizational groups, and an overall development of the employees through leisure activities.

The organization management platform registers 1203 each of the employees with one or more organizational groups selected by the employees. In this example, the organization management platform registers a newly recruited employee with the assimilation group. However, once a particular employee has been successfully inducted into the organization, the organization management platform enables the employees to select and register with one or more of the other organizational groups. Furthermore, the organization management platform enables each of the employees to select a virtual 1203 avatar to represent him/her. For example, an employee may select a comic character “Vegeta” as the employee's virtual avatar in the organization. The organization management platform then acquires 1204 individual tasks and rules, for example, standard operating procedures for each of the organizational groups via the GUI. The tasks acquired for the assimilation group comprise, for example, creating an induction program, scheduling of training programs, revamping training content over a predetermined duration of time, organizing a buddy system for newly recruited employees to be mentored by senior employees or the alumni, setting up an electronic calendar system for scheduling induction programs based on the availability of the senior employees or the alumni, generating an assimilation calendar that sets daily events for each of the employees during an induction process, tracking progress of the assimilation group by setting weekly quizzes, tests, etc., organizing seminars and demonstrations displaying work output of the organization, organizing a boot camp program, etc. The tasks acquired for the communication group comprise, for example, organizing training sessions for improvement of written skills of an employee, organizing weekly language tests, etc. The communication group further comprises subgroups, for example, an orators group that trains employees for oral communication. The tasks for the orators group comprise, for example, organizing group discussions, “word of the day” activities, competitions, etc.

The tasks acquired for the learning group are defined, for example, by the management based on objectives initiated in accordance with individual key result areas for each of the employees. The tasks for the learning group comprise, for example, generating and periodically updating knowledge banks, maintaining and monitoring one or more published calendar systems based on an operating rhythm for the learning group, etc. The tasks acquired for the leadership group comprise, for example, organizing guest lectures for multiple interest areas, organizing competitions for testing leadership skills of the employees, etc. Furthermore, the tasks acquired for the leadership group comprise, for example, generating weighting criteria for performance ranking, monitoring causes of attrition, developing mentoring schedules for newly promoted employees and high performing employees, etc. The tasks acquired for the standards group comprise, for example, defining standard operating procedures for each of the organizational groups, generating reference handbooks and operating manuals for operational issues of the organization, tracking and periodically updating the handbooks and the operating manuals. The tasks acquired for the fun group comprise, for example, setting year long activities such as competitions, outings, sports events, cultural activities, etc., with cross-functional teams across projects, locations, and grades.

After acquiring the tasks and rules for each of the organizational groups, the organization management platform initiates 1205 an operating rhythm for each of the organizational groups to initiate performance of their assigned tasks. The organization management platform reviews and updates 1206 the rules, for example, the standard operating procedures for each of the organizational groups. The organization management platform then monitors 1207 performance of each of the organizational groups based on the performance of the tasks. In this example, the organization management platform first monitors progress in the performance of the newly recruited employees of the assimilation group. For example, the organization management platform generates an online test on completion of a duration of training for each of the employees of the assimilation group. The organization management platform generates a report of the performance of each of the newly recruited employees in the assimilation group for notifying the senior employees within the assimilation group. The senior employees of the assimilation group can, for example, ask a newly recruited employee to leave the organization if the employee fails to meet required performance standards set by the online test. The assimilation group can self-govern and make decisions to notify the employee to leave the organization without intervention from management.

The organization management platform, based on inputs received from a supervisory employee within the organizational group, queries 1208 status of completion of the tasks using a configurable dashboard display interface by posting notification messages on the configurable dashboard display interface and obtains 1208 the responses to the queries from the employees. For example, the organization management platform posts a query message on the dashboard display interface requesting a testing group within a particular organizational group to report the number of failed test cases for a particular software code. The organization management platform receives a response as a status message reporting the number of failed test cases, the number of resolved test cases, and a probable duration of time required for resolving the failed test cases via the configurable dashboard display interface.

Based on the responses received from the employees of the organizational groups, the organization management platform determines 1209 whether there are any critical failures preventing functioning of the organizational groups. If the organization management platform determines a critical failure preventing the functioning of the organizational groups, the organization management platform performs 1210 a root cause analysis as disclosed in the detailed description of FIGS. 10A-10B, and automatically generates a report detailing the causes of failure. The organization management platform transmits the report to the employees of the organizational groups associated with the causes of failure. Furthermore, the organizational group determines criticality of the failure. If the failure was critical enough to stall the functioning of one or more organizational groups, the organization management platform generates a product knowledge test to be completed by all the employees of the organizational group, and notifies the employees of the date within which the product knowledge test needs to be completed. The organization management platform configures periodic audio alerts to remind an employee of the product knowledge test when the employee logs into the organization management platform. The organization management platform then reviews and updates 1206 the rules, that is, the standard operating procedures of the organizational groups for overcoming the failure and repeats the steps 1207, 1208, and 1209. For example, the organization management platform updates the standard operating procedure with additional quality checks and reviews to be performed at the end of each step of an operation routine of the particular organizational group.

If there are no failures reported to the organization management platform, the organization management platform determines 1211 whether a predetermined time period for monitoring the performance of the employees is completed. For example, if the organization management platform is configured with a monitoring time period of a month, the organization management platform monitors the performance of the employees for a month and records a verified status for the employees at the end of the month. If the predetermined time period for monitoring the performance of the employees is not completed, the organization management platform returns to the initiation 1205 of the operating rhythm and continues to monitor 1207 the performance of the employees. If the predetermined time period for monitoring the performance of the employees is completed, the organization management platform measures 1212 the performance of the tasks by each of the employees in each of the organizational groups. The organization management platform determines 1213 whether each employee has performed an assigned task according to the rules, that is, the standard operating procedures defined for the organizational group. If the employee has performed the tasks according to the rules of the organizational group, the organization management platform allocates 1214 a positive electronic currency to the employee based on performance criteria. The organization management platform sets the performance criteria, for example, as an extent of compliance with the terms set by a service level agreement between the organizational group and the organization. The organization management platform transmits 1215 the allocated number of units of electronic currency to the incentive account maintained for the employee by the organization management platform. If the employee has not performed the tasks in accordance with the rules of the organizational group, the organization management platform allocates 1216 a negative predetermined number of units of electronic currency to the incentive account of the employee. That is, equivalently, the organization management platform deducts a predetermined number of units of electronic currency from the incentive account of the employee.

After allocation of the units of electronic currency to the employee, the organization management platform compares 1217 relative progress in the performance of the tasks by each of the employees in each of the organizational groups for predetermined time duration T1, for example, a time period of three months. The organization management platform checks 1218 whether a particular employee in an organizational group has the highest number of units of electronic currency. If the employee has the highest number of units of electronic currency, the organization management platform dynamically transforms 1219 the virtual avatar of that employee to include a tagged inscription reading “leader”. If the employee does not have the highest number of units of electronic currency, the organization management platform returns to the initiating 1205 the operating rhythm for that employee. The organization management platform continues to track 1220 the performance of each of the employees for a second predetermined time duration T2. The time duration T2 is greater than or equal to T1. The time duration T2 is a minimum time period for evaluation of accrual of the units of electronic currency in the incentive account of an employee. The organization management platform determines 1221 whether a predetermined number of units of electronic currency that defines the minimum number of units of electronic currency qualifying an employee for a promotion has been accrued by each of the employees. If a particular employee has accrued the predetermined number of units of electronic currency, the organization management platform notifies 1222 senior management of the organization that the employee is due for a promotion. If the employee has not accrued the predetermined number of units of electronic currency, the organization management platform returns to tracking the performance of the employee for the next operating rhythm 1205.

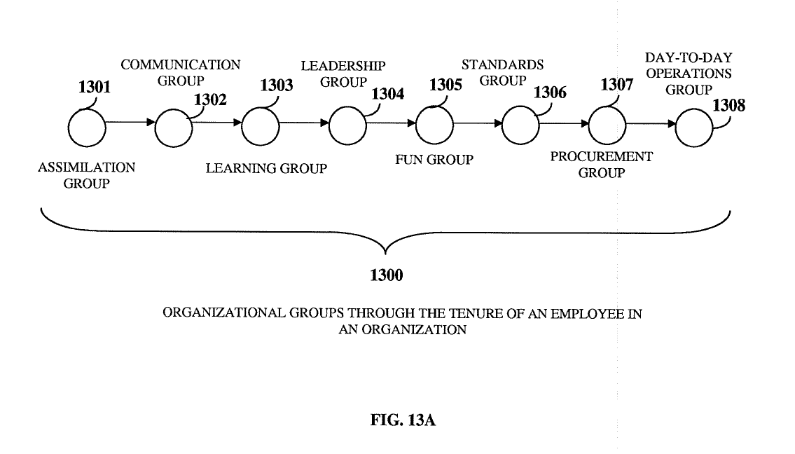

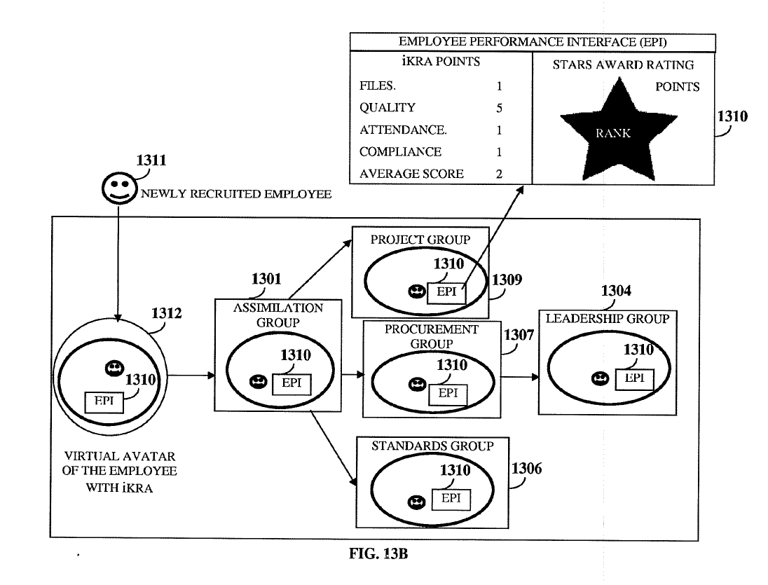

FIGS. 13A-13B exemplarily illustrate a graphical representation of a series of organizational groups 1300 selected and traversed by an employee in the organization over a predetermined duration of time. FIG. 13A exemplarily illustrates a schematic diagram of organizational groups 1300 selected by an employee through a tenure of the employee in the organization. The organization management platform creates the organizational groups 1300 based on the target goal criteria of the organization. In an example, an employee first registers with an assimilation group 1301 on the organization management platform at a point of induction of the employee into the organization. The employee then registers with a communication group 1302 on the organization management platform for improving his/her oral and written communication skills, etc., and then with a learning group 1303 on the organization management platform for acquiring work skills and knowledge across multiple technical areas. When the employee feels that he/she has a reasonable amount of experience working in the organization, the employee may then prepare to lead or mentor groups of junior employees by registering with a leadership group 1304 on the organization management platform. The employee may also actively initiate or volunteer for cross-team interactive activities, team building activities, stress management workshops, etc., by selecting and registering with a fun group 1305 on the organization management platform. After a few years of experience, the employee may be inducted into a standards group 1306 on the organization management platform for setting, for example, technical standards, compliance standards, etc., for the organization. The employee may also select and register with a procurement group 1307 on the organization management platform for actively involving himself/herself in procurement activities of the organization, for example, procurement of machine parts, etc. The employee may attain a managerial position that involves supervision of day to day operations of multiple organizational groups 1300 and teams. The employee may select and register with a day-to-day operations group 1308 on the organization management platform for discussing and planning day-to-day activities of a particular organizational group 1301, 1302, 1303, 1304, 1305, 1306, 1307, or 1308, receiving inputs on daily progress of each of the teams from other managers associated with the teams across the organization, etc. When the employee performs tasks in each of the organizational groups 1300, the organization management platform allocates one or more units of electronic currency that can be accrued in the employee's incentive account and carried by the employee through the employee's tenure in the organization.

FIG. 13B exemplarily illustrates a block diagram displaying one or more of the organizational groups 1300 exemplarily illustrated in FIG. 13A, in which the employee is registered. An employee is represented in the virtual social network environment by a virtual avatar 1312. A newly recruited employee 1311 first registers with the assimilation group 1301 on the organization management platform for induction into the organization. Based on the interest of the particular employee to gain proficiency in a particular technical area or a non-technical area, the employee may then move to the procurement group 1307, a project group 1309, or the standards group 1306 that determines the best practices for the organization. The project group 1309, for example, may be constituted for establishing cross-project planning and communication. The employee may register with the leadership group 1304 on the organization management platform after a particular duration of time, when the employee has gained enough experience to reach a managerial position in the organization. The organization management platform monitors the performance of the employee through the different organizational groups 1300 using an employee performance interface (EPI) 1310. The employee performance interface 1310 retrieves and displays the employee's performance measured, for example, in terms of the number of units of electronic currency accrued by the employee, or in term of a performance indication score represented by a “star reward” rating. The organization management platform monitors the employee performance interface 1310 for proposing a promotion for the employee.

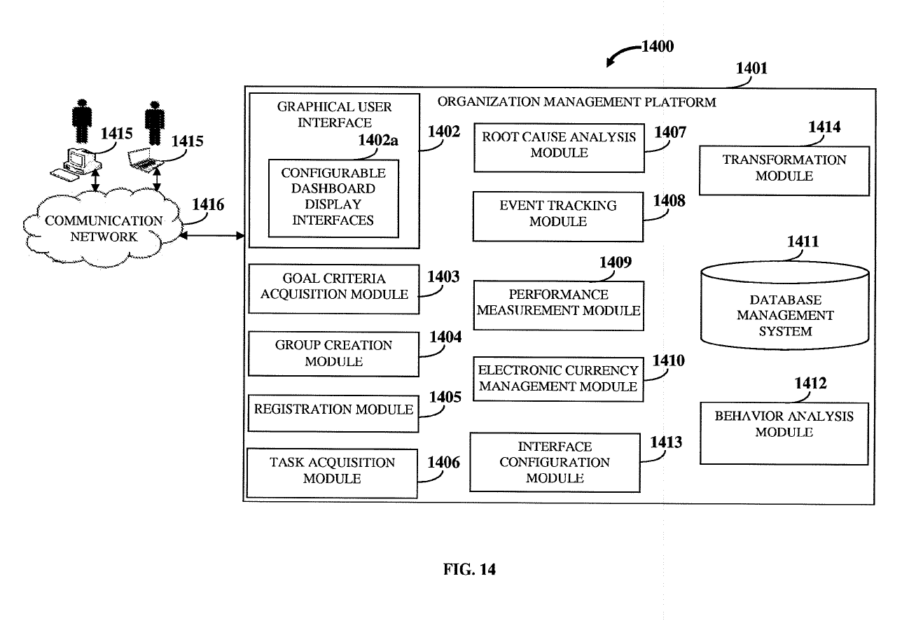

FIG. 14 exemplarily illustrates a computer implemented system 1400 for managing an organization in a virtual social network environment. The computer implemented system 1400 disclosed herein comprises an organization management platform 1401 accessible to multiple employees and clients of the organization over a communication network 1416. The employees and clients of the organization, also referred to as “users”, can establish a connection to the organization management platform 1401 over the communication network 1416 using computing devices 1415, for example, personal computers, laptops, mobile communication devices, tablet computing devices, personal digital assistants, cellular phones, etc. The communication network 1416 is, for example, the internet, an intranet, a local area network, a wide area network, a communication network implementing Wi-Fi® of the Wireless Ethernet Compatibility Alliance, Inc., a cellular network, a mobile communication network, etc. The organization management platform 1401 comprises at least one processor configured to execute modules 1402, 1403, 1404, 1405, 1406, 1407, 1408, 1409, 1410, 1411, 1412, 1413, 1414, etc., of the organization management platform 1401. In an embodiment, the organization management platform 1401 is hosted on an online server and is accessible to the computing devices 1415 of the employees and the clients over the communication network 1416.

The organization management platform 1401 comprises a graphical user interface (GUI) 1402, a goal criteria acquisition module 1403, a group creation module 1404, a registration module 1405, a task acquisition module 1406, an event tracking module 1408, a performance measurement module 1409, an electronic currency management module 1410, an interface configuration module 1413, and a transformation module 1414. The GUI 1402 provided by the organization management platform 1401 comprises, for example, web pages hosted on the organization management platform 1401 that display multiple user interfaces and configurable dashboard display interfaces 1402a for acquiring inputs from the employees, the clients, etc., of the organization. The goal criteria acquisition module 1403 acquires target goal criteria comprising, for example, key result areas of the organization, service level agreements associated with each of the key result areas, predetermined characteristics for creation of organizational groups 1300 exemplarily illustrated in FIG. 13A, etc., of the organization from one or more employees of the organization via the GUI 1402, over the communication network 1416 as disclosed in the detailed description of FIG. 1. The goal criteria acquisition module 1403 allocates individual key result areas for each of the employees associated with the selected organizational groups 1300 from the target goal criteria acquired for the organization.

The group creation module 1404 creates multiple organizational groups 1300 in the virtual social network environment based on the acquired target goal criteria. The group creation module 1404 generates and provides reusable templates on the GUI 1402 for dynamically generating the organizational groups 1300 and enabling management of the organization groups 1300 by the employees of the organization.

The registration module 1405 registers one or more of the employees with one or more of the organizational groups 1300, selected by the employees via the GUI 1402 over the communication network 1416. In an embodiment, the registration module 1405 selects a virtual avatar for each of the employees in the organization based on inputs received from each of the employees via the GUI 1402, over the communication network 1416, for identifying each of the employees in the organization.

The task acquisition module 1406 acquires one or more tasks and one or more rules for performing the tasks that enable the employees in each of the selected organizational groups 1300 to fulfill the acquired target goal criteria, via the GUI 1402, over the communication network 1416. In an embodiment, the GUI 1402 of the organization management platform 1401 comprises one or more configurable dashboard display interfaces 1402a for transmitting and/or receiving notifications of status of the performance of the tasks associated with the selected organizational groups 1300 from one or more of the employees to the other employees of the organization. In an embodiment, the configurable dashboard display interface 1402a is configured by the interface configuration module 1413. The event tracking module 1408 maps the acquired tasks to calendar events, tracks the calendar events associated with the organizational groups 1300, transmits requests for performing the tasks mapped to the calendar events to each of the employees in each of the selected organizational groups 1300, and transmits reminder notifications of the calendar events periodically to each of the employees in each of the selected organizational groups 1300.

The performance measurement module 1409 measures performance of the tasks by each of the employees in each of the selected organizational groups 1300 based on the acquired rules and performance criteria. In an embodiment, the performance measurement module 1409 generates recommendations for successful performance of the acquired tasks and notifies the generated recommendations to each of the employees in the selected organizational groups 1300 via the GUI 1402. The interface configuration module 1413 selectively displays information on progress of the tasks performed by each of the employees in each of the selected organizational groups 1300 on one or more configurable dashboard display interfaces 1402a on the GUI 1402 to the employees and the clients of the organization based on a profile of each of the employees and each of the clients of the organization.

The electronic currency management module 1410 allocates one or more units of electronic currency to each of the employees in each of the selected organizational groups 1300 based on the measured performance. In an embodiment, the electronic currency management module 1410 transmits the units of electronic currency allocated to each of the employees across the selected organizational groups 1300 to an incentive account associated with each of the employees for accumulation. In an embodiment, the electronic currency management module 1410, in communication with the performance measurement module 1409, allocates a positive electronic currency for a successful performance of the tasks in accordance with the acquired rules to fulfill the acquired target goal criteria of the organization, and allocates a negative electronic currency for a failed performance of the tasks in accordance with the acquired rules to fulfill the acquired target goal criteria. Furthermore, the electronic currency management module 1410 allocates a greater number of units of electronic currency to each of the employees in each of the selected organizational groups 1300, when each of the employees performs one or more other tasks in one or more other organizational groups 1300. In an embodiment, the electronic currency management module 1410 allocates one or more units of electronic currency to each of the employees in each of the selected organizational groups 1300 based on a weight assigned to each of the acquired tasks and/or each of the organizational groups 1300. The electronic currency management module 1410 assigns each weight to each of the tasks and/or each of the organizational groups 1300 based on predetermined weighting criteria as disclosed in the detailed description of FIG. 1.

The electronic currency management module 1410 monitors a total number of the allocated units of electronic currency accrued by each of the employees over a predetermined duration of time for tracking progress of each of the employees. In an embodiment, the performance measurement module 1409, in communication with the electronic currency management module 1410, monitors progress in the performance of the tasks by each of the employees in each of the selected organizational groups 1300 over a predetermined duration of time, by tracking the allocated units of electronic currency accrued by each of the employees over the predetermined duration of time. In an embodiment, the performance measurement module 1409 monitors relative progress of each of the organizational groups 1300 based on the performance of the tasks by each of the employees associated with each of the organizational groups 1300 over a predetermined duration of time.

Furthermore, in an embodiment, the transformation module 1414 dynamically transforms the virtual avatar selected for each of the employees in the organization, when each of the employees accrues a predetermined number of allocated units of electronic currency.

In an embodiment, the organization management platform 1401 further comprises a root cause analysis module 1407 for performing a root cause analysis for identifying one or more causes of failure in performing the tasks, and for identifying one or more of the organizational groups 1300 responsible for the identified causes of failure. For example, the root cause analysis module 1407 generates a series of linked queries iteratively for identifying the causes of failure in performing the tasks, and transmits one or more of the generated set of the linked queries to the organizational groups 1300 via the GUI 1402 for obtaining responses that identify the causes of failure from the employees in each of the organizational groups 1300. The root cause analysis module 1407 generates and tracks completion of a product knowledge test via the GUI 1402 for overcoming the identified causes of failure notified to each of the employees of the organizational groups 1300 associated with the identified causes of failure. The root cause analysis module 1407 automatically updates the rules for the performance of the tasks for overcoming the identified causes of failure.

In an embodiment, the organization management platform 1401 further comprises a behavioral analysis module 1412 for performing a behavioral analysis of each of the employees in the selected organizational groups 1300 based on an analysis of conformance of each of the employees with the acquired rules, and a number of the allocated units of electronic currency accrued by each of the employees for each of the acquired tasks, and an analysis of interactions among the employees in the organization. The interface configuration module 1413 extracts the interactions from one or more configurable dashboard display interfaces 1402a on the GUI 1402 for enabling the behavioral analysis module 1412 to perform the behavioral analysis. The organization management platform 1401 further comprises a database management system 1411 for storing the acquired tasks, rules, units of electronic currency accrued by the employees, etc.

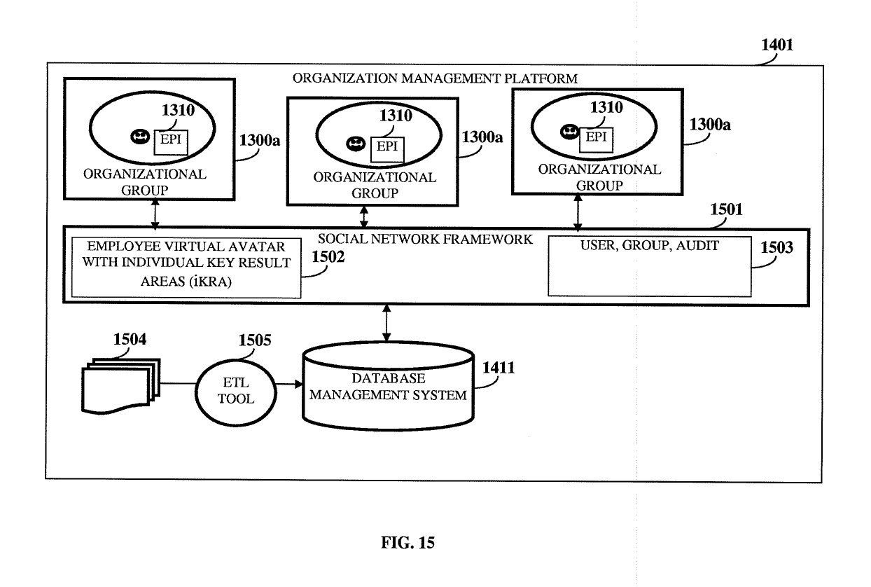

FIG. 15 exemplarily illustrates a schematic diagram of a logical structure of the organization management platform 1401 in a virtual social network environment. The organization management platform 1401 organizes the structure of the organization into multiple organizational groups 1300 as exemplarily illustrated in FIG. 13A. As exemplarily illustrated in FIG. 15, each organizational group 1300a communicates with and receives inputs from a social network framework 1501 configured on the organization management platform 1401. The social network framework 1501 comprises a software component 1502 that manages individual employee information, for example, information on the virtual avatar of the employee, individual key result areas associated with the employee, etc., for each of the organizational groups 1300. The social network framework 1501 further comprises a software component 1503 that manages user profiles of the employees, the clients, etc., of the organization, group information, and audit information for each of the organizational groups 1300. The database management system 1411 of the organization management platform 1401 stores the acquired target goal criteria, tasks and rules associated with each of the organizational groups 1300, etc. The database management system 1411 comprises database entities configured as database tables that maintain a mapping between each of the employees and their associated individual key result areas, number of units of electronic currency accrued for a predetermined duration of time, performance indication scores, tasks performed for each of the organizational groups 1300, etc.

Furthermore, the organization management platform 1401 further comprises an extract-transform-load (ETL) tool 1505 configured to automatically extract client operations data, for example, invoicing data, billing data, back office data, etc., that may be formatted as spreadsheet files 1504, from multiple client specific data stores. The ETL tool 1505 integrates the extracted data, transforms the formats of the extracted data to a format of data objects stored in the database management system 1411, and loads the transformed data to the database management system 1411. The organization management platform 1401 analyzes the client operations data to determine the implementation of the tasks by the organizational groups 1300 in accordance with the key result areas, for example, cost effectiveness of execution of each of the tasks by each of the organizational groups 1300, time taken for completion of the tasks by each of the organizational groups 1300, etc. Therefore, the ETL tool 1505 provides inputs to the organization management platform 1401 for the measurement of the performance of the tasks by each of the organizational groups 1300 and each of the employees of each of the organizational groups 1300 in accordance with the key result areas for the organizational groups 1300 by retrieving the client operations data from disparate sources, for example, customer platforms where the employees of an organizational group work, and transferring the retrieved client operations data to the database management system 1411.

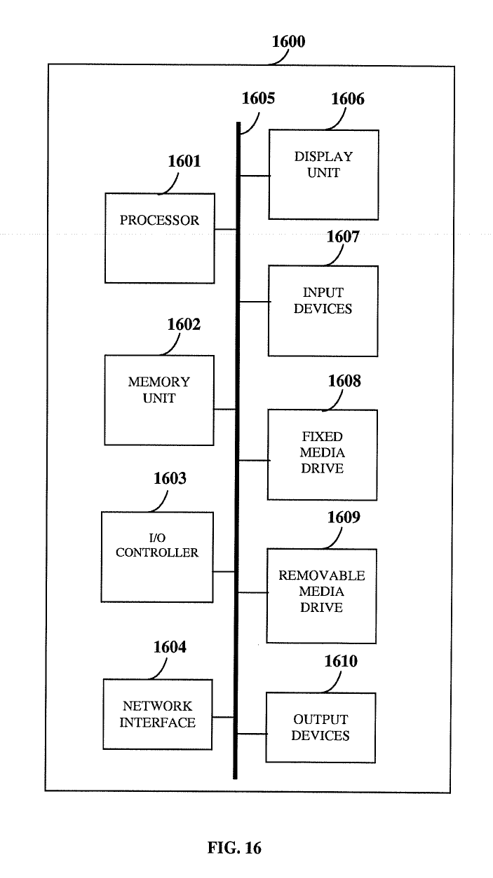

FIG. 16 exemplarily illustrates the architecture of a computer system 1600 employed by the organization management platform 1401 for managing an organization in a virtual social network environment. The organization management platform 1401 of the computer implemented system 1400 exemplarily illustrated in FIG. 14 employs the architecture of the computer system 1600 exemplarily illustrated in FIG. 16.

The organization management platform 1401 communicates with the computing devices 1415 of the employees and the clients of the organization via the communication network 1416, for example, a short range network or a long range network. The communication network 1416 is, for example, the internet, a local area network, a wide area network, a wireless network, a mobile communication network, etc. The computer system 1600 comprises, for example, a processor 1601, a memory unit 1602 for storing programs and data, an input/output (I/O) controller 1603, a network interface 1604, a data bus 1605, a display unit 1606, input devices 1607, a fixed media drive 1608, a removable media drive 1609 for receiving removable media, output devices 1610, etc.

The processor 1601 is an electronic circuit that executes computer programs. The memory unit 1602 is used for storing programs, applications, and data. For example, the goal criteria acquisition module 1403, the group creation module 1404, the registration module 1405, the task acquisition module 1406, the performance measurement module 1409, the interface configuration module 1413, the event tracking module 1408, the root cause analysis module 1407, the electronic currency management module 1410, the transformation module 1414, the behavioral analysis module 1412, etc., of the organization management platform 1401 are stored in the memory unit 1602 of the computer system 1600 of the organization management platform 1401. The memory unit 1602 is, for example, a random access memory (RAM) or another type of dynamic storage device that stores information and instructions for execution by the processor 1601. The memory unit 1602 also stores temporary variables and other intermediate information used during execution of the instructions by the processor 1601. The computer system 1600 further comprises a read only memory (ROM) or another type of static storage device that stores static information and instructions for the processor 1601.

The network interface 1604 enables connection of the computer system 1600 to the communication network 1416. For example, the organization management platform 1401 connects to the communication network 1416 via the network interface 1604. The network interface 1604 comprises, for example, an infrared (IR) interface, an interface implementing Wi-Fi® of the Wireless Ethernet Compatibility Alliance, Inc., a universal serial bus (USB) interface, a local area network (LAN) interface, a wide area network (WAN) interface, etc. The I/O controller 1603 controls input actions and output actions performed by the organization management platform 1401. The data bus 1605 permits communications between the modules, for example, 1402, 1403, 1404, 1405, 1406, 1407, 1408, 1409, 1410, 1412, 1413, 1414, etc., of the organization management platform 1401.

The display unit 1606 of the organization management platform 1401, via the GUI 1402, displays information, for example, display interfaces, icons such as the virtual avatar icons, user interface elements such as text fields, checkboxes, etc., for selecting organizational groups 1300 as exemplarily illustrated in FIG. 13A, and for selecting virtual avatars with whom an employee or a client needs to communicate, the reports generated based on the root cause analysis performed by the organization management platform 1401, an online product knowledge test initiated by the organization management platform 1401 for each of the employees of the organization, the units of electronic currency accrued in the incentive account by each of the employees of the organization, etc. Furthermore, the display unit 1606 displays configurable dashboard display interfaces 1402a on the GUI 1402 or enabling chat conversations between the employees, transmitting and/or receiving notifications, etc. The input devices 1607 are used for inputting data into the computer system 1600. The employees and/or the clients of the organization use the input devices 1607 to provide inputs to the organization management platform 1401. For example, one or more employees may enter details of the selected virtual avatar, the target goal criteria, the tasks and rules for each of the organizational groups 1300, etc., using the input devices 1607. The input devices 1607 are, for example, a keyboard such as an alphanumeric keyboard, a joystick, a pointing device such as a computer mouse, a touch pad, a light pen, etc.

The output devices 1610 output the results of operations performed by the organization management platform 1401. For example, the organization management platform 1401 notifies each of the employees of a calendar event scheduled at a particular time, transmits an audio alert reminder for each of the employees to take up the product knowledge test, etc., using the output devices 1610. The organization management platform 1401 displays a pop-up window on the GUI 1402 indicating, for example, the number of units of electronic currency accrued in the incentive account by each of the employees on completion of an assigned task. Furthermore, the organization management platform 1401 displays via the GUI 1402 the dynamically transformed virtual avatar of an employee, when the employee accrues a predetermined number of units of electronic currency.

Computer applications and programs are used for operating the computer system 1600. The programs are loaded onto the fixed media drive 1608 and into the memory unit 1602 of the computer system 1600 via the removable media drive 1609. In an embodiment, the computer applications and programs may be loaded directly via the communication network 1416. Computer applications and programs are executed by double clicking a related icon displayed on the display unit 1606 using one of the input devices 1607.

The computer system 1600 employs an operating system for performing multiple tasks. The operating system is responsible for management and coordination of activities and sharing of resources of the computer system 1600. The operating system further manages security of the computer system 1600, peripheral devices connected to the computer system 1600, and network connections. The operating system employed on the computer system 1600 recognizes, for example, inputs provided by the employees using one of the input devices 1607, the output display, files, and directories stored locally on the fixed media drive 1608, for example, a hard drive. The operating system on the computer system 1600 executes different programs using the processor 1601. The processor 1601 retrieves instructions for executing the modules, for example, 1402, 1403, 1404, 1405, 1406, 1407, 1408, 1409, 1410, 1412, 1413, 1414, etc., of the organization management platform 1401 from the memory unit 1602. A program counter determines the location of the instructions in the memory unit 1602. The program counter stores a number that identifies the current position in the program of each of the modules, for example, 1402, 1403, 1404, 1405, 1406, 1407, 1408, 1409, 1410, 1412, 1413, 1414, etc., of the organization management platform 1401.

The instructions fetched by the processor 1601 from the memory unit 1602 after being processed are decoded. The instructions are stored in an instruction register in the processor 1601. After processing and decoding, the processor 1601 executes the instructions. For example, the goal criteria acquisition module 1403 defines instructions for acquiring target goal criteria of the organization from one or more of the employees of the organization via the GUI 1402, over the communication network 1416. The goal criteria acquisition module 1403 defines instructions for allocating individual key result areas for each of the employees in the selected organizational groups 1300 from the acquired target goal criteria. The group creation module 1404 defines instructions for creating multiple organizational groups 1300 in the virtual social network environment based on the acquired target goal criteria. The group creation module 1404 defines instructions for generating and providing reusable templates on the GUI 1402 for dynamically generating the organizational groups 1300 and enabling the employees of the organization to manage the organizational groups 1300. The registration module 1405 defines instructions for registering one or more of the employees with one or more of the organizational groups 1300, selected by the employees via the GUI 1402 over the communication network 1416. In an embodiment, the registration module 1405 defines instructions for selecting a virtual avatar for each of the employees in the organization based on inputs received from each of the employees via the GUI 1402, over the communication network 1416, for identifying each of the employees in the organization.

The task acquisition module 1406 defines instructions for acquiring one or more tasks and one or more rules for performing the tasks that enable the employees in each of the selected organizational groups 1300 to fulfill the acquired target goal criteria, via the GUI 1402, over the communication network 1416. The event tracking module 1408 defines instructions for mapping the acquired tasks to calendar events, tracking the calendar events associated with the organizational groups 1300, transmitting requests for performing the tasks mapped to the calendar events to each of the employees in each of the selected organizational groups 1300, and transmitting reminder notifications of the calendar events periodically to each of the employees in each of the selected organizational groups 1300.

The performance measurement module 1409 defines instructions for measuring performance of the tasks by each of the employees in each of the selected organizational groups 1300 based on the acquired rules and performance criteria. In an embodiment, the performance measurement module 1409 defines instructions for generating recommendations for successful performance of the tasks and for notifying the generated recommendations to each of the employees in the selected organizational groups 1300 via the GUI 1402. The interface configuration module 1413 defines instructions for selectively displaying information on progress of the tasks performed by each of the employees in each of the selected organizational groups 1300 on one or more configurable dashboard display interfaces 1402a on the GUI 1402 to the employees and the clients of the organization based on a profile of each of the employees and the clients of the organization.

The electronic currency management module 1410 defines instructions for allocating one or more units of electronic currency to each of the employees in each of the selected organizational groups 1300 based on the measured performance. In an embodiment, the electronic currency management module 1410 defines instructions for transmitting the units of electronic currency allocated to each of the employees across the selected organizational groups 1300 in an incentive account associated with each of the employees for accumulation. In an embodiment, the electronic currency management module 1410 defines instructions for allocating a positive electronic currency for a successful performance of the tasks in accordance with the acquired rules to fulfill the acquired target goal criteria of the organization, and for allocating a negative electronic currency for a failed performance of the tasks in accordance with the acquired rules to fulfill the acquired target goal criteria.

Furthermore, the electronic currency management module 1410 defines instructions for allocating a greater number of units of electronic currency to each of the employees in each of the selected organizational groups 1300, when each of the employees performs one or more other tasks in one or more other organizational groups 1300. The electronic currency management module 1410 defines instructions for monitoring a total number of the allocated units of electronic currency accrued by each of the employees over a predetermined duration of time for tracking progress of each of the employees. In an embodiment, the performance measurement module 1409 defines instructions for monitoring relative progress of each of the organizational groups 1300 based on the performance of the tasks by each of the employees associated with each of the organizational groups 1300 over a predetermined duration of time. In an embodiment, the electronic currency management module 1410 defines instructions for allocating one or more units of electronic currency to each of the employees in each of the selected organizational groups 1300 based on a weight assigned to each of the acquired tasks and each of the organizational groups 1300. The electronic currency management module 1410 defines instructions for assigning the weights to the tasks and/or the organizational groups 1300 based on predetermined weighting criteria.

The transformation module 1414 defines instructions for dynamically transforming the selected virtual avatar of each of the employees in the organization, when each of the employees accrues a predetermined number of the allocated units of electronic currency. In an embodiment, the performance measurement module 1409 defines instructions for monitoring progress in the performance of the tasks by each of the employees in each of the selected organizational groups 1300 over a predetermined duration of time, by tracking the allocated units of electronic currency accrued by each of the employees over the predetermined duration of time.

The root cause analysis module 1407 defines instructions for performing a root cause analysis for identifying one or more causes of failure in performing the tasks, and for identifying one or more of the organizational groups 1300 responsible for the identified causes of failure. The root cause analysis module 1407 defines instructions for generating a series of linked queries iteratively for identifying the causes of failure in performing the tasks, and for transmitting the generated series of the linked queries to the organizational groups 1300 via the GUI 1402 for obtaining responses that identify the causes of failure from the employees in each of the organizational groups 1300. The root cause analysis module 1407 defines instructions for generating and tracking completion of a product knowledge test via the GUI 1402 for overcoming the identified causes of failure notified to each of the employees of the organizational groups 1300 associated with the identified causes of failure. The root cause analysis module 1407 further defines instructions for automatically updating the acquired rules for the performance of the tasks for overcoming the identified causes of failure. The behavioral analysis module 1412 defines instructions for performing a behavioral analysis of each of the employees in the selected organizational groups 1300 based on an analysis of conformance of each of the employees with the acquired rules, and a number of the allocated units of electronic currency accrued by each of the employees for each of the acquired tasks, and an analysis of interactions among the employees in the organization. The interface configuration module 1413 defines instructions for extracting the interactions from one or more configurable dashboard display interfaces 1402a on the GUI 1402.

The processor 1601 of the computer system 1600 employed by the organization management platform 1401 retrieves the instructions defined by the goal criteria acquisition module 1403, the group creation module 1404, the registration module 1405, the task acquisition module 1406, the performance measurement module 1409, the interface configuration module 1413, the event tracking module 1408, the root cause analysis module 1407, the behavioral analysis module 1412, the electronic currency management module 1410, and the transformation module 1414 of the organization management platform 1401 and executes the instructions.

At the time of execution, the instructions stored in the instruction register are examined to determine the operations to be performed. The processor 1601 then performs the specified operations. The operations comprise arithmetic operations and logic operations. The operating system performs multiple routines for performing a number of tasks required to assign the input devices 1607, the output devices 1610, and memory for execution of the modules, for example, 1402, 1403, 1404, 1405, 1406, 1407, 1408, 1409, 1410, 1412, 1413, 1414, etc., of the organization management platform 1401. The tasks performed by the operating system comprise, for example, assigning memory to the modules, for example, 1402, 1403, 1404, 1405, 1406, 1407, 1408, 1409, 1410, 1412, 1413, 1414, etc., of the organization management platform 1401, and to data used by the organization management platform 1401, moving data between the memory unit 1602 and disk units, and handling input/output operations. The operating system performs the tasks on request by the operations and after performing the tasks, the operating system transfers the execution control back to the processor 1601. The processor 1601 continues the execution to obtain one or more outputs. The outputs of the execution of the modules, for example, 1402, 1403, 1404, 1405, 1406, 1407, 1408, 1409, 1410, 1412, 1413, 1414, etc., of the organization management platform 1401 are displayed to the user on the display unit 1606.

Disclosed herein is also a computer program product comprising a non-transitory computer readable storage medium that stores computer program codes comprising instructions executable by at least one processor 1601 for managing an organization in a virtual social network environment. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 1601, except for a transitory, propagating signal. The computer program codes comprise a first computer program code for acquiring target goal criteria of an organization from one or more employees of the organization via the GUI 1402, over the communication network 1416; a second computer program code for creating multiple organizational groups 1300 in the virtual social network environment based on the acquired target goal criteria; a third computer program code for registering one or more of the employees with one or more of the organizational groups 1300 selected by the employees via the GUI 1402, over the communication network 1416; a fourth computer program code for acquiring one or more tasks and one or more rules for performing the tasks that enable the employees in each of the selected organizational groups 1300 to fulfill the acquired target goal criteria, via the GUI 1402, over the communication network 1416; a fifth computer program code for measuring performance of the tasks by each of the employees in each of the selected organizational groups 1300, based on the acquired rules and performance criteria; and a sixth computer program code for allocating one or more units of electronic currency to each of the employees in each of the selected organizational groups 1300 based on the measured performance. The computer program product disclosed herein further comprises one or more additional computer program codes for performing additional steps that may be required and contemplated for managing an organization in a virtual social network environment. In an embodiment, a single piece of computer program code comprising computer executable instructions performs one or more steps of the computer implemented method disclosed herein for managing an organization in a virtual social network environment.

The computer program codes comprising computer executable instructions are embodied on the non-transitory computer readable storage medium. The processor 1601 of the computer system 1600 retrieves these computer executable instructions and executes them. When the computer executable instructions are executed by the processor 1601, the computer executable instructions cause the processor 1601 to perform the steps of the computer implemented method for managing an organization in a virtual social network environment.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises computer program codes for implementing the processes of various embodiments.

Where databases are described such as the database management system 1411, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

1-10. (canceled)

11. A system for rules-based performance analysis, the system comprising:
at least one processor;
a database management system;
a communication network for allowing users to access the rules-based performance analysis system, wherein the users comprise at least one of employees and clients of the organization;
a set of rules stored in the database management system, the rules defining acceptable practices for achieving any of a plurality of goals;
a first plurality of goals stored in the database management system defining acceptable performance levels for the company with respect to services provided by the company to customers of the company;
a second plurality of goals stored in the memory and defining acceptable performance levels for the employees with respect to services provided by the employees for the company;
a plurality of templates stored in the memory and defining a plurality of organizational groups of employees within the company;
a customizable display interface allowing users of the rule-based performance analysis system to manage employees and services by interacting with the set of rules, first plurality of goals, the second plurality of goals and the plurality of templates,
wherein the customizable display displays a representation of progress in achieving at least one goal of the first and second pluralities of goals in accordance with the set of rules.

12. The rules-based performance analysis system of claim 11, further comprising a plurality of user account records stored in the database management system, each user account record corresponding to an employee, wherein a virtual avatar may be associated with each user account record, and wherein the customizable display interface allows users of the rules-based performance analysis system to manage the user account records.

13. The rules-based performance analysis system of claim 11, further comprising an escalation matrix stored in the database management system, the escalation matrix having a hierarchy of employees to be contacted to resolve an issue relating to achievement of at least one of the first and second plurality of goals, wherein the customizable display interface allows users of the rules-based performance analysis system to manage the escalation matrix.

14. The computer-implemented system of claim 11, further comprising a plurality of polls stored in the memory, wherein users can vote on the polls using the customizable display interface.

15. The computer-implemented system of claim 11, further comprising a plurality of reminders stored in the database management system, wherein users can interact with the reminders using the customizable display interface.

16. The computer-implemented system of claim 11, wherein the representation of progress is a graphical representation.

17. The computer-implemented system of claim 11, wherein the representation of progress is a performance indication score.

18. The computer-implemented system of claim 11, wherein the representation of progress is a an amount of a virtual currency.

19. The computer-implemented system of claim 18, wherein the a user can redeem the virtual currency via the customizable display interface.

20. The computer-implemented system of claim 11, wherein the set of rules is stored as at least one service level agreement.

21. The computer-implemented system of claim 11, the processor configured to monitor and analyze employee activity in relation to the set of rules and first and second pluralities of goals and to generate and store in the database system a report providing likely causes of problems in achieving the goals and likely solutions to the problems.

22. The computer-implemented system of claim 19, the report being further stored in a collection of such reports, the collection of reports being accessible via the customizable display interface.

23. The computer-implemented system of claim 11, the processor configured to monitor and analyze employee activity in relation to the set of rules and first and second pluralities of goals and to generate and store in the database system a report predicting employee behavior based on the monitoring.

24. The computer-implemented system of claim 11, wherein the set of rules comprises a balanced scorecard system that aligns the first and second pluralities of goals.

25. A computer-implemented method for rules-based performance analysis, the method comprising:
acquiring and storing in a database system a set of rules defining acceptable practices for achieving any of a plurality of goals;
acquiring and storing in the database system a first plurality of goals defining acceptable performance levels for the company with respect to services provided by the company to customers of the company;
acquiring and storing in the database system a second plurality of goals defining acceptable performance levels for the employees with respect to services provided by the employees for the company;
storing in the database system a plurality of templates defining a plurality of organizational groups of employees within the company;
generating a customizable display interface allowing users of the computer-implemented method to manage employees and services by interacting with the first plurality of goals, the second plurality of goals, and the plurality of templates,
wherein the customizable display displays a representation of progress in achieving at least one goal of the first and second pluralities of goals in accordance with the set of rules.

26. The computer-implemented method of claim 25, further comprising a storing a plurality of user account records in the database management system, each user account record corresponding to an employee, wherein a virtual avatar may be associated with each user account record, and wherein the customizable display interface allows users of the rules-based performance analysis system to manage the user account records

27. The computer-implemented method of claim 25, further comprising storing an escalation matrix in the database management system, the escalation matrix having a hierarchy of employees to be contacted to resolve an issue relating to achievement of at least one of the first and second plurality of goals, wherein the customizable display interface allows users of the rules-based performance analysis system to manage the escalation matrix.

28. The computer-implemented method of claim 25, further comprising storing in the database management system a plurality of polls, wherein users can vote on the polls using the customizable display interface.

29. The computer-implemented method of claim 25, further comprising storing in the database management system a plurality of reminders, wherein users can interact with the reminders using the customizable display interface.

30. The computer-implemented method of claim 25, wherein the representation of progress is a graphical representation.

31. The computer-implemented method of claim 25, wherein the representation of progress is a performance indication score.

32. The computer-implemented method of claim 25, wherein the representation of progress is a an amount of a virtual currency.

33. The computer-implemented method of claim 32, wherein the a user can redeem the virtual currency via the customizable display interface.

34. The computer-implemented method of claim 25, wherein the first and second pluralities of goals are stored as service level agreements.

35. The computer-implemented method of claim 25, further comprising monitoring and analyzing, with a computer processor, employee activity relating to the set of rules and the first and second pluralities of goals and generating and storing in the database management system a report providing likely causes of problems in achieving the goals and likely solutions to those problems.

36. The computer-implemented method of claim 35, the report being further stored in a collection of such reports, the collection of reports being accessible via the customizable display interface.

37. The computer-implemented method of claim 25, further comprising monitoring and analyzing, with a computer processor. employee activity relating to the first and second pluralities of goals and to generating and storing in a memory a report predicting employee behavior based on the monitoring.

38. The computer-implemented method of claim 25, wherein the set of rules comprises a balanced scorecard system that aligns the first and second pluralities of goals.
